(19) United States
(12) Patent Application Publication
(10) Pub. No.: US 2026/0260668 A1
(43) Pub. Date: Sep. 3, 2026

(54) METHOD AND APPARATUS FOR ENCAPSULATING 3D REGION RELATED ANNOTATION IN A MEDIA FILE

(71) Applicant: CANON KABUSHIKI KAISHA, Tokyo (JP)

(72) Inventors: Hervé RUELLAN, RENNES (FR); Franck DENOUAL, SAINT DOMINEUC (FR); Frédéric MAZE, LANGAN (FR); Naël OUEDRAOGO, VAL D'ANAST (FR); Toru SUNEYA, Tokyo (JP)

(21) Appl. No.: 18/719,211

(22) PCT Filed: Dec. 14, 2022
(86) PCT No.: PCT/EP2022/085987

§ 371 Date: Jun. 12, 2024

(30) Foreign Application Priority Data
Dec. 16, 2021 (GB) 2118337.1

(51) Int. Cl. G11B 27/34

(52) U.S. Cl. CPC G11B 27/34

(57) ABSTRACT

The present invention concerns a method of encapsulating volumetric media in a file, the method comprising: generating a volumetric media entity (200) describing the volumetric media; generating a 3D region annotation entity (210) related to a region of the volumetric media, the 3D region annotation entity being associated with the volumetric media entity; generating geometry data (220) associated with the 3D region annotation entity and describing the geometry of a region of the volumetric media; generating at least one annotation data structure (230, 231, 232, 931, 932, 933) associated with the 3D region annotation entity; and embedding the volumetric media entity, the 3D region annotation entity, the geometry data and the at least one annotation data structure in the file.

### FIELD OF THE INVENTION

The present disclosure concerns a method and a device for encapsulation of information related to a three-dimensional region in a media file.

### BACKGROUND OF INVENTION

LIDAR devices and volumetric media analysis services can generate localized metadata for volumetric media. Localized metadata are metadata related to a region, a portion, of a media content and not to the whole media content. The media content is typically a point cloud, a volumetric media, but it may also be any type of three-dimensional media content. For example, a LIDAR may generate different regions for a point cloud according to their capture time. As another example, a deep-learning system may identify objects inside a volumetric media. These localized metadata may be seen as three-dimensional region annotations.

Media content captured by a camera or a LiDAR or processed by a media analysis service are stored on a storage device like a memory card, for example. The media content is typically encoded to reduce the size of data on the storage device. MPEG is currently standardizing the representation of volumetric media, i.e. 3D “images” or 3D “videos”.

G-PCC, Geometry-based Point Cloud Compression, enables to compress a point cloud. The media is a set of 3D points with associated properties, called attributes. The compression of the media is based on the geometry of the point cloud as defined by the coordinates of its points. Other properties of the point cloud are represented as attributes of the points, for example colour, reflectance, opacity. Typically, G-PCC is used to encode a point cloud generated by a LiDAR.

V3C, Visual Volumetric Video-based Coding, enables to compress volumetric media, and V-PCC, Video-based Point Cloud Compression, applies these techniques on point clouds. The 3D representation of the media is first converted into multiple 2D representations which are encoded using classic image or video codecs (e.g., AVC, HEVC, VVC . . . ). Typically, V3C or V-PCC are used to encode a 3D object used in Virtual/Augmented/Mixed reality contents.

A volumetric media encoded using G-PCC, V3C or V-PCC can be stored inside a file using ISO Base Media File Format (ISOBMFF-ISO/IEC 14496-12), or a derived specification. Extensions to ISOBMFF are being proposed for storing volumetric media, such as ISO/IEC 23090-10 for the carriage of visual volumetric video-based coding data, or ISO/IEC 23090-18 for the carriage of Geometry-based Point Cloud Compression Data. In the following, “ISOBMFF” refers to ISOBMFF and its extensions for the carriage of volumetric media.

While providing the ability to store documents containing metadata such as EXIF or XMP documents, ISOBMFF and extensions to ISOBMFF for the carriage of volumetric media do not provide a mechanism adapted to linking annotations to a three-dimensional region of a volumetric media.

### SUMMARY OF THE INVENTION

The present invention has been devised to address one or more of the foregoing concerns.

According to an aspect of the invention, it is proposed a method of encapsulating volumetric media in a file, the method comprising:
generating a volumetric media entity describing the volumetric media;
generating a 3D region annotation entity related to a region of the volumetric media, the 3D region annotation entity being associated with the volumetric media entity;
generating geometry data associated with the 3D region annotation entity and describing the geometry of a region of the volumetric media;
generating at least one annotation data structure associated with the 3D region annotation entity; and
embedding the volumetric media entity, the 3D region annotation entity, the geometry data and the at least one annotation data structure in the file.

According to an embodiment:
the volumetric media entity is a first item;
the 3D region annotation entity is a second item; and
the geometry data is associated with the second item.

According to an embodiment, the at least one annotation data structure is a property of the second item.

According to an embodiment, the at least one annotation data structure is an item associated with the second item.

According to an embodiment, the geometry data is comprised in the second item.

According to an embodiment, the geometry data is comprised within the first item.

According to an embodiment, the geometry data is determined from an identifier associated with points of the volumetric media.

According to an embodiment, the geometry data is a third item.

According to an embodiment, wherein the at least one annotation data structure is a group of at least one item.

According to an embodiment, the at least one item represents a plane within the volumetric media.

According to an embodiment:
the volumetric media entity is a volumetric media track and the volumetric media is comprised in a sample of the volumetric media track;
the 3D region annotation entity is a 3D region annotation track; and
the geometry data is comprised in a sample of the 3D region annotation track.

According to an embodiment:
the volumetric media entity is a volumetric media track and the volumetric media is comprised in a sample of the volumetric media track;
the 3D region annotation entity is a 3D region annotation track; and
the geometry data is comprised in a sample of another track associated with the 3D region annotation track.

According to an embodiment, the at least one annotation is an item property associated with a group of samples of the 3D region annotation track.

According to an embodiment, the 3D region annotation track is associated with a track providing a representation of the region of interest described in the 3D region annotation track.

According to another aspect of the invention, it is proposed a method for reading a file comprising volumetric media, the method comprising:
reading a volumetric media entity describing the volumetric media for obtaining the volumetric media;
reading a 3D region annotation entity related to a region of the volumetric media, the 3D region annotation entity being associated with the volumetric media entity;
reading geometry data associated with the 3D region annotation entity and describing the geometry of a region of the volumetric media;
reading at least one annotation data structure associated with the 3D region annotation entity for obtaining annotation data; and
processing the obtained volumetric media and the obtained at least one annotation data in function of the geometry of the region of the volumetric media.

According to another aspect of the invention, it is proposed a computer program product for a programmable apparatus, the computer program product comprising a sequence of instructions for implementing a method according to the invention, when loaded into and executed by the programmable apparatus.

According to another aspect of the invention, it is proposed a non-transitory computer-readable storage medium storing instructions of a computer program for implementing a method according to the invention.

According to another aspect of the invention, it is proposed a computer program which upon execution causes the method of the invention to be performed.

According to another aspect of the invention, it is proposed a device for encapsulating volumetric media in a file, the device comprising a processor configured for:
generating a volumetric media entity describing the volumetric media;
generating a 3D region annotation entity related to a region of the volumetric media, the 3D region annotation entity being associated with the volumetric media entity;
generating geometry data associated with the 3D region annotation entity and describing the geometry of a region of the volumetric media;
generating at least one annotation data structure associated with the 3D region annotation entity; and
embedding the volumetric media entity, the 3D region annotation entity, the geometry data and the at least one annotation data structure in the file.

According to another aspect of the invention, it is proposed a device for reading a file comprising volumetric media, the device comprising a processor configured for:
reading a volumetric media entity describing the volumetric media for obtaining the volumetric media;
reading a 3D region annotation entity related to a region of the volumetric media, the 3D region annotation entity being associated with the volumetric media entity;
reading geometry data associated with the 3D region annotation entity and describing the geometry of a region of the volumetric media;
reading at least one annotation data structure associated with the 3D region annotation entity for obtaining annotation data; and
processing the obtained volumetric media and the obtained at least one annotation data in function of the geometry of the region of the volumetric media.

At least parts of the methods according to the invention may be computer implemented. Accordingly, the present invention may take the form of an entirely hardware embodiment, an entirely software embodiment (including firmware, resident software, microcode, etc.) or an embodiment combining software and hardware aspects that may all generally be referred to herein as a “circuit”, “module” or “system”.

Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Embodiments of the invention will now be described, by way of example only, and with reference to the following drawings in which:

FIG. 1 illustrates an example of an ISOBMFF file that contains media data like one or more still images and possibly video or sequence of images;

FIG. 2a illustrates a high-level view of the invention for associating annotations to a region of a volumetric media;

FIG. 2b illustrates an example of 3D region annotations;

FIG. 3 illustrates a first embodiment of the invention;

FIG. 4 illustrates a second embodiment of the invention;

FIG. 5 illustrates a third embodiment of the invention;

FIG. 6 illustrates the main steps of a process for adding a new 3D region annotation to a volumetric media item stored in an ISOBMFF file according to embodiments of the invention;

FIG. 7 illustrates the main steps of a process for reading an ISOBMFF file containing 3D region annotations according to embodiments of the invention;

FIG. 8 illustrates a process for processing an ISOBMFF file containing a volumetric media and one or more 3D region annotation items associated with this volumetric media according to embodiments of the invention;

FIG. 9a and FIG. 9b illustrates a fourth embodiment of the invention;

FIG. 10 illustrates a fifth embodiment for annotation regions in a volumetric media track;

FIG. 11 is a schematic block diagram of a computing device for implementation of one or more embodiments of the invention.

### DETAILED DESCRIPTION OF THE INVENTION

In all the description the term image is used as a generic term encompassing both 2D images and 3D images or volumetric images. Similarly, the term video is used as a generic term encompassing both 2D videos and 3D videos or volumetric media. Volumetric media may encompass media encoded with G-PCC, V3C or V-PCC.

The ISOBMFF standard (see document «Information technology—Coding of audiovisual objects—Part 12: ISO base media file format», w20295, ISO/IEC 14496-12, seventh edition, May 2021) covers two forms of storage corresponding to different use cases:
the storage of timed media data (e.g., a video or an image sequence) as a timed sequence of related samples, and
the storage of non-timed media data as a single item or a collection of items.

The ISO Base Media file format is object-oriented. It is composed of building blocks called boxes corresponding to data structures characterized by a unique type identifier, typically a four-characters code, also noted FourCC or 4CC. Full boxes are data structures similar to boxes comprising in addition a version and flags value attributes. In the following, the term box may designate both full boxes or boxes. Those boxes or full boxes are hierarchically or sequentially organized in the ISOBMFF file and define parameters describing the encoded timed or non-timed media data, its structure and timing, if any. All data in an encapsulated media file (media data and metadata describing the media data) is contained in boxes. There is no other data within the file. File-level boxes are boxes that are not contained in other boxes.

A presentation of timed media data is described in a File-level box called a movie box (with the four-character code ‘moov’). This movie box represents an initialization information container containing a set of various boxes describing the presentation and its timing. It is logically divided into tracks represented by track boxes (with the four-character code ‘trak’). Each track (uniquely identified by a track identifier (track_ID)) represents a timed sequence of media data belonging to the presentation (frames of video, audio samples, or sequence of images, for example). On contrary to frames of a video, a sequence of images designates a timed sequence of images for which the timing is only advisory; it may be the timing at collection (e.g. of an image burst) or the suggested display timing (e.g. for a slide show).

Within each track, each timed unit of data is called a sample; this might be a frame of video, audio or timed metadata, or an image of a sequence of images. Samples are implicitly numbered in decoding order sequence. Each track box contains a hierarchy of boxes describing the samples of a track, e.g. a sample table box (‘stbl’) contains all the time and data indexing of the media samples in a track. The actual sample data are stored in boxes called Media Data Boxes (with the four-character code ‘mdat’) or Identified Media Data Boxes (with the four-character code ‘imda’, similar to the Media Data Box but containing an additional identifier) at the same level as the movie box

Non-timed media data is described in a meta box (with the four-character code ‘meta’). A unit of non-timed media data under this box and its hierarchy relates to “information item” or “item” instead of related samples. It is to be noted that the wording ‘box’ and the wording ‘container’ may be both used with the same meaning to refer to data structures that contain metadata describing the organization or/and properties of the image data in the file.

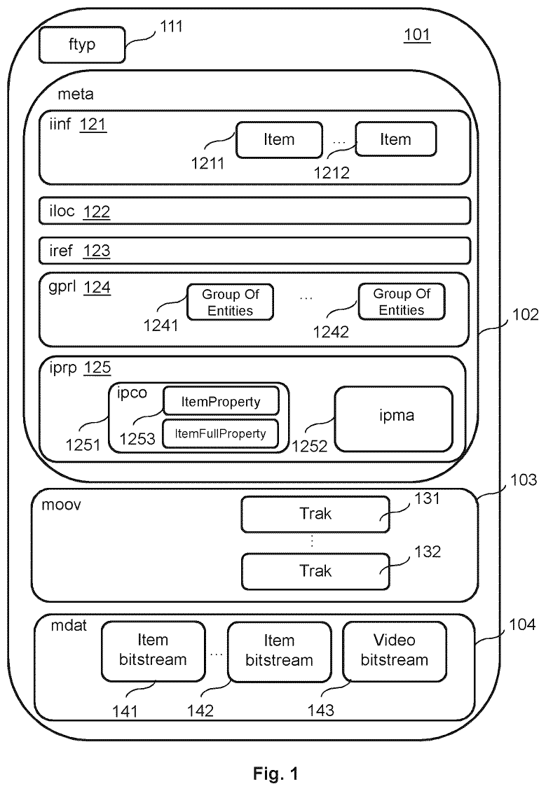

FIG. 1 illustrates an example of an ISOBMFF file 101 that contains media data like one or more still images and possibly one or more video and/or one or more sequences of images. This file contains a first ‘ftyp’ box (FileTypeBox) 111 that contains an identifier of the type of file (typically a set of four character codes). This file contains a second box called ‘meta’ (MetaBox) 102 that is used to contain general untimed metadata including metadata structures describing the one or more still images. This ‘meta’ box 102 contains an ‘iinf’ box (ItemInfoBox) 121 that describes several single images. Each single image is described by a metadata structure ItemInfoEntry also denoted items 1211 and 1212. Each item has a unique 16-bit or 32-bit identifier item_ID. The media data corresponding to these items is stored in the container for media data, the ‘mdat’ box 104. An ‘iloc’ box (ItemLocationBox) 122 provides for each item the offset and length of its associated media data in the ‘mdat’ box 104. An ‘iref’ box (ItemReferenceBox) 123 may also be defined to describe the association of one item with other items via typed references.

Optionally, for describing the storage of image sequences or video, the ISOBMFF file 101 may contain a third box called ‘moov’ (MovieBox) 103 that describes one or more image sequences or video tracks 131 and 132. Typically, the track 131 may be an image sequence track designed to describe a set of images for which the temporal information is not necessarily meaningful and 132 may be a video (‘vide’) track designed to describe video content. Both tracks describe a series of image samples, an image sample being a set of pixels captured at the same time, for example a frame of a video sequence. The main difference between the two tracks is that in image sequence tracks the timing information is not necessarily meaningful whereas for ‘vide’ tracks the timing information is intended to constraint the timing of the display of the samples. The data corresponding to these samples is stored in the container for media data, the ‘mdat’ box 104.

The ‘mdat’ container 104 stores the untimed encoded images corresponding to items as represented by the data portions 141 and 142 and the timed encoded images corresponding to samples as represented by the data portion 143.

An ISOBMFF file 101 offers different alternatives to store multiple images. For instance, it may store the multiple images either as items or as a track of samples. The actual choice is typically made by the application or device generating the file according to the type of images and the contemplated usage of the file.

ISOBMFF specifies several alternatives to group samples or items depending on the container that holds the samples or items to group. These alternatives can be considered as grouping data structures or grouping mechanism, i.e., boxes or data structures providing metadata describing a grouping criterion and/or group properties and/or group entities.

A first grouping mechanism represented by an EntityToGroupBox is adapted for the grouping of items or tracks. In this mechanism, the wording ‘entity’ is used to refer to items or tracks or other EntityToGroupBoxes. This mechanism specifies the grouping of entities. An EntityToGroupBox is defined according to the following syntax:

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
// the remaining data may be specified for a particular grouping_type
}
```

The grouping_type is used to specify the type of the group. The group_id provides an identifier for the group of entities. The entity_id represents the identifier of entities that compose the group, i.e., either a track_ID for a track, an item_ID for an item or another group_id for an entity group. In FIG. 1, the groups of entities inheriting from the Entity ToGroup box 1241 and 1242 are comprised in the container 124 identified by the four characters code ‘gprl’ for GroupsListBox.

Entity grouping consists in associating a grouping type which identifies the reason of the grouping of a set of items, tracks or other entity groups. In this document, it is referred to Grouping Information as information in one of the EntityToGroup Boxes which convey information to group a set of images.

ISOBMFF provides a mechanism to describe and associate properties with items. These properties are called item properties. The ItemPropertiesBox ‘iprp’ 125 enables the association of any item with an ordered set of item properties. The ItemPropertiesBox consists of two parts: an item property container box ‘ipco’ 1251 that contains an implicitly indexed list of item properties 1253, and an item property association box ‘ipma’ 1252 that contains one or more entries. Each entry in the item property association box associates an item with its item properties. The ISOBMFF standard extends this mechanism to enable the association of item properties with items and/or entity groups, for instance by using the ‘unif’ brand. Note that in the description, for genericity, we generally use item properties to designate both properties of an item or properties of an entity group. An item property associated with an entity group applies to the entity group as a whole and not individually to each entity within the group.

The associated syntax is as follows:

```
aligned(8) class ItemProperty(property_type)
  extends Box (property_type)
{
}
aligned(8) class ItemFullProperty(property_type, version, flags)
  extends FullBox(property_type, version, flags)
{
}
aligned(8) class ItemPropertyContainerBox
  extends Box(′ipco′)
{
  properties ItemProperty( ) [ ]; // boxes derived from
    // ItemProperty or ItemFullProperty, to fill box
}
aligned(8) class ItemPropertyAssociation
  extends FullBox(‘ipma’, version, flags)
{
unsigned int(32) entry_count;
  for(i = 0; i < entry_count; i++) {
    if (version < 1)
      unsigned int(16) item_ID;
    else
      unsigned int(32) item_ID;
    unsigned int(8) association_count;
    for (i=0; i<association_count; i++) {
      bit(1) essential;
      if (flags & 1)
        unsigned int(15) property_index;
      else
        unsigned int(7) property_index;
    }
  }
}
aligned(8) class ItemPropertiesBox
    extends Box(‘iprp’) {
  ItemPropertyContainerBox property_container;
  ItemPropertyAssociation association[ ];
}
```

The ItemProperty and ItemFullProperty boxes are designed for the description of an item property. ItemFullProperty allows defining several versions of the syntax of the box and may contain one or more parameters whose presence is conditioned by either the version or the flags parameter.

The ItemPropertyContainerBox is designed for describing a set of item properties as an array of ItemProperty boxes or ItemFullProperty boxes.

The ItemPropertyAssociation box is designed to describe the association between items and/or entity groups and their item properties. It provides the description of a list of item identifiers and/or entity group identifiers, each identifier (item_ID) being associated with a list of item property index referring to an item property in the ItemPropertyContainerBox.

None of these mechanisms allow describing some properties associated with a portion, or a region of a volumetric media. The invention aims at solving this problem by providing ways of describing 3D region annotations and to associate these 3D region annotations with actual regions of a volumetric media.

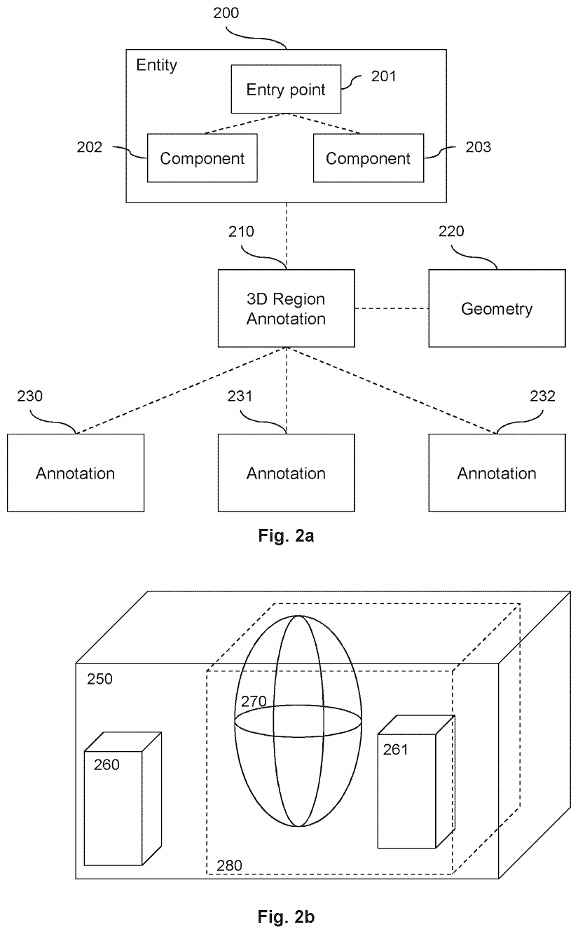

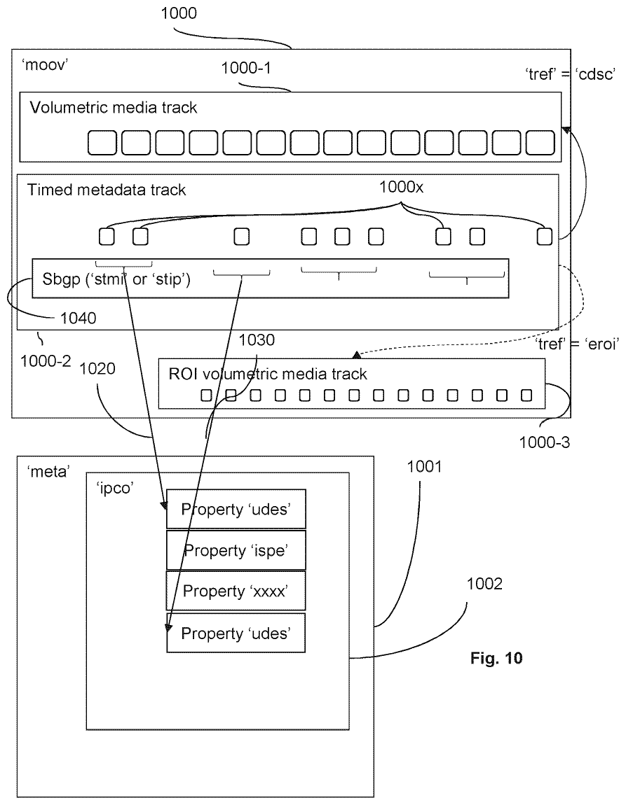

FIG. 2a illustrates a high-level view of the invention for associating annotations to a region of a volumetric media. A region annotation 210 is associated with an entity 200. The entity 200 may correspond to a volumetric media contained in a single item. It may also correspond to the entry point of a volumetric media contained in several items: an entry point item 201 and one or more component items 202 and 203. This entity is for example a G-PCC item, a V3C item or a V-PCC item that describes some volumetric media. It can also be another type of item, a track (as illustrated in FIG. 10) or an entity group. This association means that the region annotation 210 comprises information related to a region, meaning a portion, of the volumetric media, or entity group, described by the entity 200.

For instance, in single item encapsulation, respectively single-track encapsulation, of G-PCC data, the entity 200 is a G-PCC item, respectively a G-PCC track, describing the bitstream representing all the components of a G-PCC frame, respectively multiple G-PCC frames. The region annotation 210 is associated with the entity 200 representing a G-PCC item, respectively a G-PCC track, via an item reference, respectively a track reference, from the region annotation 210 to the entity 200.

Alternatively, in multi-items encapsulation, respectively multi-tracks encapsulation, of G-PCC data, the entity 200 is represented by multiple G-PCC component items, respectively G-PCC component tracks:
one G-PCC item or track carrying the G-PCC geometry component representing the entry point item or track 201; and,
zero or more G-PCC items or tracks 202 and 203 carrying the G-PCC attribute components.

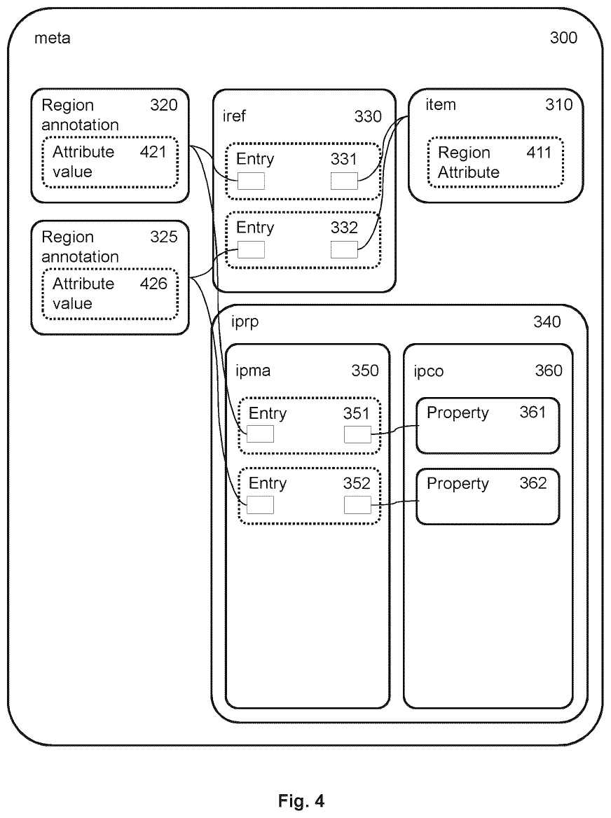

In this case, the region annotation 210 is preferably associated with the entry point 201 representing the G-PCC geometry component via an item reference, respectively a track reference, from the region annotation 210 to the G-PCC item, respectively track, representing the entry point 201. Alternatively, the region annotation 210 may be associated with the G-PCC item or track carrying the attribute component referred by the region annotation 210 when the geometry of a region is determined from an attribute value as illustrated by FIG. 4).

Alternatively, in multi-items encapsulation, respectively multi-tracks encapsulation, of tiled G-PCC data, the entity 200 is represented by multiple G-PCC items, respectively G-PCC tracks:
one G-PCC item or track representing a G-PCC tile base item or G-PCC tile base track carrying all of parameter sets and tile inventory data units and no geometry or attribute data unit; and,
at least one G-PCC tile item or G-PCC tile track carrying the geometry and attribute components.

In a variant, a G-PCC tile can also be encapsulated in multiple G-PCC tile items or G-PCC tile tracks: a G-PCC tile item or G-PCC tile track carrying the geometry component and zero or more G-PCC tile items or G-PCC tile tracks carrying the attribute components.

In above cases, the G-PCC tile base item or G-PCC tile base track represents the entry point 201. The region annotation 210 can be associated with the entry point 201 representing the G-PCC tile base item, respectively G-PCC tile base track, via an item reference, respectively a track reference, from the region annotation 210 to the entry point 201. Alternatively, it may be useful to associate annotations tile by tile for filtering the annotations depending on the tiles that are accessed by a parser or renderer. In such case, the region annotation 210 describing regions to be annotated in a tile can be associated with the G-PCC tile item or G-PCC tile track carrying the geometry component of the tile to annotate. Alternatively, the region annotation 210 may be associated with the G-PCC tile item or G-PCC tile track carrying the attribute component referred by the region annotation 210, for example when the geometry of a region is determined from an attribute value as illustrated by FIG. 4.

In another example, for multi-items or multi-tracks encapsulation of V3C data, the entity 200 is represented by multiple items or tracks: a V3C atlas item or V3C atlas track carrying the coded atlas access unit(s) of V3C data represents the entry point 201 and V3C component items or V3C component tracks carrying the geometry and attribute components of the V3C data represent the components 202 and 203. In this case, the region annotation 210 is preferably associated with the entry point 201 representing the V3C atlas item, respectively the V3C atlas track, via an item reference, respectively a track reference, from the region annotation 210 to the entry point 201.

In case of V3C tiled data, the region annotation 210 may be associated with the V3C atlas item, respectively the V3C atlas track, or with the V3C atlas tile item, respectively the V3C atlas tile track, corresponding to the tile to annotate, via an item reference, respectively a track reference, from the region annotation 210 to the V3C atlas item, respectively the V3C atlas track, or to the V3C atlas tile item, respectively the V3C atlas tile track.

Alternatively, the region annotation 210 may be associated with the V3C item, respectively the V3C track, carrying the geometry component, via an item reference, respectively a track reference, from the region annotation 210 to the V3C item, respectively V3C track, carrying the geometry component. Alternatively, the region annotation 210 may be associated with the V3C item or V3C track carrying the attribute component referred by the region annotation 210, for example when the geometry of a region is determined from an attribute value as illustrated by FIG. 4) In case of a media file with V3C items, respectively with V3C tracks, with multiple atlases, the region annotation 210 may be associated with the V3C atlas item, respectively the V3C atlas track, it corresponds to, via an item reference, respectively a track reference, from the region annotation 210 to the V3C atlas item, respectively the V3C atlas track. The item or track reference type may be ‘cdsc’ to indicate that the region annotation provides a description of the referenced item or track.

When the entity is a G-PCC item, a V3C item or a V-PCC item, the reconstructed media is the volumetric media resulting from decoding a coded volumetric media item or from applying the operation of a derived item to a set of input items (that are themselves coded volumetric media items or derived volumetric media items). The output volumetric media is the volumetric media resulting from applying the potential transformative item properties of the volumetric media item to the reconstructed volumetric media. For example, the output volumetric media can be the volumetric media obtained after decoding the data associated with the item and applying transformative item properties on the decoded volumetric media.

This 3D region annotation 210 may be defined by its geometry 220. The geometry may be defined as a location, a location and a shape, a set of points or as a mask. For example, the geometry of a region may be a rectangular cuboid defined by its centre and its width, length, and height. The geometry may be defined by other means. The geometry may be split into a location and optionally a shape. Several kinds of shape can be defined: for example, a point (in such case the geometry is only a location), a rectangular cuboid, or an ellipsoid. The location is the position inside the annotated volumetric media of a reference point for the shape. For example, the reference point may be the centre of a rectangular cuboid or the centre of an ellipsoid . . . . The geometry can also be defined as a mask, selecting individual points in the volumetric media corresponding to the entity 200. Other geometries can also be used, such as a 3D mesh. The geometry may be described with one generic identifier plus a parameter providing its type (point, rectangular cuboid, ellipsoid . . . ) or as a specific identifier per type. For a volumetric media encapsulated within an ISOBMFF file, this identifier may be a four character-code.

The geometry may be stored in the data of the 3D region annotation 210, typically in an ‘mdat’ box. It may be stored in one or more other entities associated with the 3D region annotation 210. It may be stored in one or more item properties associated to the 3D region annotation 210.

The 3D region annotation 210 may be linked to one or more annotations 230, 231, and 232. These annotations are used to store different annotations corresponding to the 3D region annotation 210 of the entity 200. An annotation can be for example an object detected in the volumetric media, a GPS location corresponding to an object in the volumetric media, a description for a part of the volumetric media, the text contained in a region of the volumetric media, a user annotation for a part of the volumetric media, or any kind of information associated with the region.

FIG. 2b illustrates an example of 3D region annotations. The volumetric data 250 is for example captured by a LiDAR. The LiDAR adds, at capture time, information about two persons that were detected. The persons correspond to the 3D regions 260 and 261 in the volumetric data 250. Both 3D regions are rectangular cuboid regions. This captured volumetric media may be stored in an ISOBMFF file using the invention.

Later on, for example while transferring the volumetric media 250 into an online-based volumetric data storage, further processing is applied on the volumetric media, enhancing the information describing the volumetric media. First, a recognition algorithm finds the name of the person represented by region 261. Second, an object detection algorithm detects and identifies a building in the region 270 of the volumetric media 250. This region is an ellipsoidal region. These processing steps result in an annotated volumetric media that may be stored in an ISOBMFF file using the invention. For example, the ISOBMFF file containing the volumetric media 250 is edited to store the description of the new 3D region annotations 270 and/or the name of the detected person in the 3D region 261.

Last, a user edits the volumetric media 250, for example to keep only the part containing the known person in region 261 and the building in region 270. As a result, only the part 280 of the volumetric media 250 is kept. These editing steps result in an edited volumetric media that may be stored in an ISOBMFF file using the invention. The so-edited ISOBMFF file may then contain either the original volumetric media 250 plus the instruction to obtain the cropped volumetric media 280, or it may contain only the volumetric media description and data for the region 280.

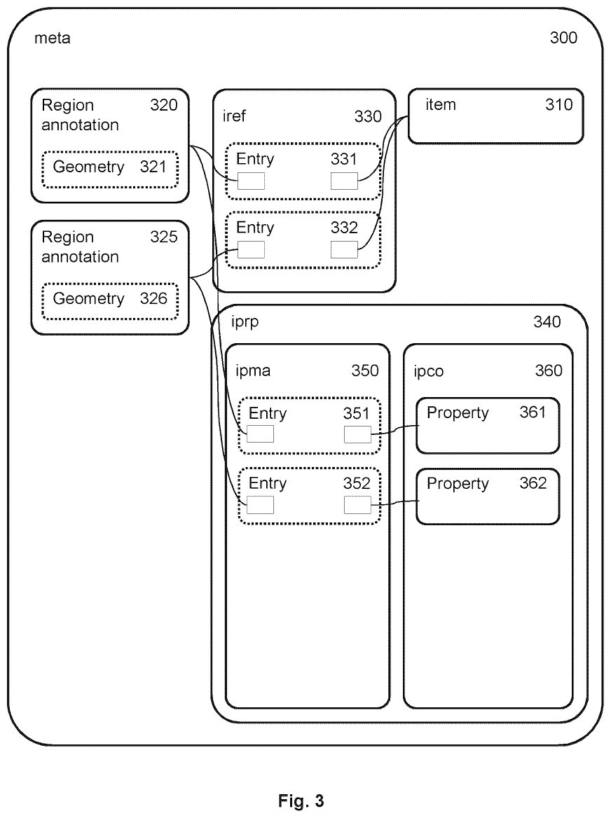

FIGS. 3 to 8 illustrates some embodiments of the invention for the ISOBMFF standard or any derived standard, where the 3D region annotation 210 is represented using an item.

FIG. 3 illustrates a first embodiment of the invention. The ‘meta’ box 300 contains an item 310, corresponding for example to a volumetric media item. Possibly the item 310 is the entry point to a volumetric media. The ‘meta’ box 300 also contains two other items 320 and 325 that correspond to 3D region annotations. The geometry of these two 3D region annotation items is described in their respective contents, indicated as geometry 321 and geometry 326. These contents are identified in the ‘iloc’ box. The content of a 3D region annotation item may be stored preferably in an ‘idat’ box. It may also be stored in either an ‘mdat’ or an ‘imda’ box.

The ‘iref’ box 330 contains two entries, 331 and 332 associating the 3D region annotation items, respectively 320 and 325, with the volumetric media item 310.

The ‘iprp’ box 340 contains the ‘ipco’ box 360 and the ‘ipma’ box 350. The ‘ipco’ box 360 contains the item properties 361 and 362 corresponding to the annotations of the two 3D region annotation items 320 and 325. The ‘ipma’ box 350 associates the 3D region annotation items 320 and 325 with their respective item properties 361 and 362 through two entries, respectively 351 and 352.

In this embodiment, a 3D region annotation item may be defined with an item_type of ‘3dan’. The 3D region annotation item may be associated with its volumetric media item through an item reference box of type ‘cdsc’.

The syntax of the content of a 3D region annotation item may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) geometry_type;
    if (geometry_type == 0) {
      // point
      signed int(field_size) x;
      signed int(field_size) y;
      signed int(field_size) z;
    }
    if (geometry_type == 1) {
      // polyline
      unsigned int(field_size) point_count;
      for (i=0; i < point_count; i++) {
        signed int(field_size) x;
        signed int(field_size) y;
        signed int(field_size) z;
      }
    }
    if (geometry_type == 2) {
      // plane
      unsigned int(field_size) point_count;
      for (i=0; i < point_count; i++) {
        signed int(field_size) x;
        signed int(field_size) y;
        signed int(field_size) z;
        signed int(field_size) normal_x;
        signed int(field_size) normal_y;
        signed int(field_size) normal_z;
      }
    }
    if (geometry_type == 3) {
      // rectangular cuboid
      signed int(field_size) x;
      signed int(field_size) y;
      signed int(field_size) z;
      signed int(field_size) size_x;
      signed int(field_size) size_y;
      signed int(field_size) size_z;
      signed int(field_size) quaternion_w;
      signed int(field_size) quaternion_x;
      signed int(field_size) quaternion_y;
      signed int(field_size) quaternion_z;
    }
    if (geometry_type == 4) {
      // ellipsoid
      signed int(field_size) x;
      signed int(field_size) y;
      signed int(field_size) z;
      signed int(field_size) size_x;
      signed int(field_size) size_y;
      signed int(field_size) size_z;
      signed int(field_size) quaternion_w;
      signed int(field_size) quaternion_x;
      signed int(field_size) quaternion_y;
      signed int(field_size) quaternion_z;
    }
  }
}
```

The semantics of the 3D region annotation item may be:
version is the version of the 3DRegionltem structure.
flags is a set of flags defining options for the structure.
field_size is an integer value specifying the size in bits (for example 32 or 64 bits) of the fields used for describing the geometry of the region. As an example, the field_size is computed here from the value of the least significant bit of the flags value. If this bit is set to 0, then the field_size is 32 bits, if this bit is set to 1, then the field_size is 64 bits.
reference_size_x, reference_size_y, reference_size_z, are fixed point decimals that specify the size in meter of the reference space in which the regions are placed.
region_count is the number of regions described in the structure.
geometry_type is the type of the geometry of a region.
x, y, z are fixed point decimals specifying the location of the region in meter inside the reference space. If the region is a point, x, y, z are the coordinates of this point. If the region is a polyline, x, y, z are the coordinates of a point of this polyline. If the region is a plane, x, y, z are the coordinates of a point in this plane. If the region is a rectangular cuboid or an ellipsoid, x, y, z are the coordinates of the centre of this rectangular cuboid or ellipsoid.
point_count is the number of points composing a polyline.
normal_x, normal_y, normal_z are fixed point decimals specifying a normal vector of the plane if the region is a plane.
size_x, size_y, size_z are fixed point decimals specifying the dimensions in meter of the rectangular cuboid or ellipsoid if the region is a rectangular cuboid or is an ellipsoid.
quaternion_w, quaternion_x. quaternion_y, quaternion_z are fixed point decimals specifying the rotation of the rectangular cuboid or ellipsoid around its centre using a quaternion representation if the region is a rectangular cuboid or ellipsoid.

As an example, the coordinates of the regions are represented here using a fixed point decimal representation. The fixed point decimal may use a 16.16 representation if the field_size is of 32 bits or a 32.32 representation if the field_size is of 64 bits. Extensions for the 3D region annotation item may be realized by defining new geometry types.

Other types of representations may be used for the coordinates of the regions, for example an integer representation, a floating point representation.

Similarly, as an example, the values quaternion_w, quaternion_x. quaternion_y, quaternion_z representing the rotation of a rectangular cuboid or of an ellipsoid are represented using a fixed point decimal representation. They may also be represented using other types of representations such as an integer representation or a floating point representation.

In this embodiment, all the item properties associated through an entry of the ‘ipma’ box to the 3D region annotation item apply to each region of the annotated volumetric media defined by the geometry of the 3D region annotation item.

Possibly, an entity may be associated with a region annotation item through an entry in the ‘iref’ box 300 to represent an annotation of the regions described by the region annotation item.

In this embodiment, the annotated volumetric media from FIG. 2b may be stored in an ISOBMFF file with the following structure:

```
FileTypeBox ′ftyp′ : major-brand = ′gpci′, compatible-brands = ′mif1′
MetaBox ′meta′: (container)
  HandlerBox ′hdlr′: ′volv′
  PrimaryItemBox ′pitm′: item_ID = 1;
  ItemInfoBox ′iinf′: entry_count = 4
    ′infe′: item_ID = 1, item_type = ′gpe1′; // (ref 250)
    ′infe′: item_ID = 2, item_type = ′3dan′, hidden = true; //
(ref 260)
    ′infe′: item_ID = 3, item_type = ′3dan′, hidden = true; //
(ref 261)
    ′infe′: item_ID = 4, item_type = ′3dan′, hidden = true; //
(ref 270)
  ItemLocationBox ′iloc′: item_count = 1
    item_ID = 1, extent_count = 1, extent_offset = X,
extent_length = Y;
    item_ID = 2, extent_count = 1, extent_offset = 01,
extent_length = L1;
    item_ID = 3, extent_count = 1, extent_offset = 02,
extent_length = L2;
    item_ID = 4, extent_count = 1, extent_offset = 03,
extent_length = L3;
  ItemReferenceBox ′iref′:
    referenceType = ′cdsc′, from_item_ID = 2, reference_count = 1,
to_item_ID = 1;
    referenceType = ′cdsc′, from_item_ID = 3, reference_count = 1,
to_item_ID = 1;
    referenceType = ′cdsc′, from_item_ID = 4, reference_count = 1,
to_item_ID = 1;
  ItemPropertiesBox ′iprp′:
    ItemPropertyContainerBox ′ipco′:
  1) ′gpcC′ // Config for annotated volumetric media
  2) ′gpsr′ // Size of annotated volumetric media
  3) ′udes′, lang = en, name = ′person′, description = ′ ′,
tags = person
  4) ′udes′, lang = fr, name = ′Jean′, description = ′ ′,
tags = person
  5) ′udes′, lang = fr, name = ′Notre Dame′, description =
′Notre Dame de Paris′, tags = building
  ItemPropertyAssociation ′ipma′: entry_count = 4
    1) item_ID = 1, association_count = 2
        essential = 1, property_index = 1;
        essential = 0, property_index = 2;
    2) item_ID = 2, association_count = 1
        essential = 0, property_index = 3;
    3) item_ID = 3, association_count = 2
        essential = 0, property_index = 3;
        essential = 0, property_index = 4;
    4) item_ID = 4, association_count = 1
        essential = 0, property_index = 5;
MediaDataBox ′mdat′ or ′idat′:
  Volumetric media (at file offset X, with length Y)
  Region Annotation (at file offset 01, with length L1)
    geometry: type = 3, x = x0, y = y0, z = z0,
      size_x = sx0, size_y = sy0, size_z = sz0,
      quaternion_w = qw0, quaternion_x = qx0,
      quaternion_y = qy0, quaternion_z = qz0;
  Region Annotation (at file offset 02, with length L2)
    geometry: type = 3, x = x1, y = y1, z = z1,
      size_x = sx1, size_y = sy1, size_z = sz1,
      quaternion_w = qw1, quaternion_x = qx1,
      quaternion_y = qy1, quaternion_z = qz1;
  Region Annotation (at file offset 03, with length L3)
    geometry: type = 4, x = x2, y = y2, z = z2,
      size_x = sx2, size_y = sy2, size_z = sz2,
      quaternion_w = qw2, quaternion_x = qx2,
      quaternion_y = qy2, quaternion_z = qz2;
```

In this ISOBMFF file, the volumetric media item 250 is represented by the item with an item_ID value of 1. The region 260 is represented by the item with an item_ID value of 2. It is associated with the item property at index 3 through the second entry of the ‘ipma’ box. This property corresponds to a person annotation. The geometry of the 3D region annotation item is described in the first region annotation part of the MediaDataBox.

The region 261 is represented by the item with an item_ID value of 3. It is associated with the item properties at index 3 and 4 through the third entry of the ‘ipma’ box. These properties correspond respectively to a person annotation and to an annotation describing a person named “Jean”. The geometry of the 3D region annotation item is described in the second region annotation part of the MediaDataBox.

The region 270 is represented by the item with an item_ID value of 4. It is associated with the item property at index 5 through the fourth entry of the ‘ipma’ box. This property corresponds to an annotation describing “Notre Dame de Paris” as a building. The geometry of the 3D region annotation item is described in the third region annotation part of the MediaDataBox.

Each 3D region annotation item is associated with the annotated volumetric media through an item reference of type ‘cdsc’.

All the 3D region annotation items may have a hidden property set to true indicating to a reader that this item is not intended to be displayed (e.g., item has (flags & 1) equal to 1 in its ItemInfoEntry).

Possibly, another item (not represented) may be associated with the 3D region annotation item 320, for example for providing a detailed view of the region. In this case, an additional entry may be added to the ‘iref’ box 330, for example with the reference type ‘eroi’, from the 3D region annotation item 320 to this other item. This other item may be a volumetric media item, an image item or an entity group. Item may also be a track as for example a volumetric media track, a video track, an audio track.

FIG. 4 illustrates a second embodiment of the invention. In this embodiment, the geometry of a region is not described in the 3D region annotation item itself but rely on information contained in the volumetric media. In this embodiment, the volumetric media corresponding to the item 310 contains an attribute used for defining regions. This attribute may be stored inside the item 310 or inside another item referenced by the item 310. This attribute may be a region identifier attribute (for example a material identifier attribute from a G-PCC or V-PCC bitstream) that is a component attribute associating a region identifier to each point of the volumetric media. Therefore, points with a common material identifier share a characteristic that may be used to identify an object or a type of object.

The 3D region annotation items 320 and 325 contain a value corresponding to a possible value of the region identifier attribute respectively shown as attribute value 421 and attribute value 426. The region corresponding to the 3D region annotation item respectively 320 or 325 is composed of all the points in the volumetric media 310 whose region identifier attribute value is the same as the value specified inside the region annotation item respectively 320 or 325.

The syntax of the content of the 3D region annotation item may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) region_identifier_value;
  }
}
```

The semantic of the 3D region annotation item may be:
region_identifier_value is the value of the region identifier attribute of the points of the volumetric media contained in the region.
The other fields have the same semantics as in the previous embodiment.

In a variant, the region_identifier_value may correspond to a tileid from a G-PCC tile inventory or a tileid from a V-PCC or V3C atlas.

In this embodiment, the annotated volumetric media from FIG. 2b may be stored in an ISOBMFF file with the following structure:

```
FileTypeBox ′ftyp′: major-brand = ′gpci′, compatible-brands = ′mif1′
MetaBox ′meta′: (container)
  HandlerBox ′hdlr′: ′volv′
  PrimaryItemBox ′pitm′: item_ID = 1;
  ItemInfoBox ′iinf′: entry_count = 4
    ′infe′: item_ID = 1, item_type = ′gpe1′; // (ref 250)
    ′infe′: item_ID = 2, item_type = ′3dan′, hidden = true; //
(ref 260)
    ′infe′: item_ID = 3, item_type = ′3dan′, hidden = true; //
(ref 261)
    ′infe′: item_ID = 4, item_type = ′3dan′, hidden = true; //
(ref 270)
  ItemLocationBox ′iloc′: item_count = 1
    item_ID = 1, extent_count = 1, extent_offset = X,
extent_length = Y;
    item_ID = 2, extent_count = 1, extent_offset = 01,
extent_length = L1;
    item_ID = 3, extent_count = 1, extent_offset = 02,
extent_length = L2;
    item_ID = 4, extent_count = 1, extent_offset = 03,
extent_length = L3;
  ItemReferenceBox ′iref′:
    referenceType = ′cdsc′, from_item_ID = 2, reference_count = 1,
to_item_ID = 1;
    referenceType = ′cdsc′, from_item_ID = 3, reference_count = 1,
to_item_ID = 1;
    referenceType = ′cdsc′, from_item_ID = 4, reference_count = 1,
to_item_ID = 1;
  ItemPropertiesBox ′iprp′:
    ItemPropertyContainerBox ′ipco′:
    1) ′gpcC′ // Config for annotated volumetric media
    2) ′gpsr′ // Size of annotated volumetric media
    3) ′udes′, lang = en, name = ′person′, description = ′ ′,
tags = person
    4) ′udes′, lang = fr, name = ′Jean′, description = ′ ′,
tags = person
    5) ′udes′, lang = fr, name = ′Notre Dame′, description =
′Notre Dame de Paris′, tags = building
  ItemPropertyAssociation ′ipma′: entry_count = 4
    1) item_ID = 1, association_count = 2
        essential = 1, property_index = 1;
        essential = 0, property_index = 2;
    2) item_ID = 2, association_count = 1
        essential = 0, property_index = 3;
    3) item_ID = 3, association_count = 2
        essential = 0, property_index = 3;
        essential = 0, property_index = 4;
    4) item_ID = 4, association_count = 1
        essential = 0, property_index = 5;
MediaDataBox ′mdat′ or ′idat′:
  Volumetric media (at file offset X, with length Y)
    // includes region identifier attribute values
  Region Annotation (at file offset 01, with length L1)
    region_identifier_value = ri0;
  Region Annotation (at file offset 02, with length L2)
    region_identifier_value = ri1;
  Region Annotation (at file offset 03, with length L3)
    region_identifier_value = ri2;
```

A specific region identifier attribute value, for example 0, may be reserved for points not belonging to a region. The default value for the region identifier attribute value may be set to this value corresponding to points not belonging to any region.

Possibly, the region identifier attribute may be a set of bits, each bit corresponding to a different region. For example, a first region may be associated with the value 1, a second region may be associated with the value 2, a third with the value 4 . . . . This enables to specify that a point belongs to several regions. For example, a point may have a region identifier attribute value of 3 for indicating that is belongs to both the first and the second region.

Possibly, the 3D region annotation item may include for each region a list of values for the region_identifier_value field. This enables to specify that some regions may intersect. For example, a first region may be associated with the values 1 and 2, and a second region may be associated with the values 2 and 3. Points belonging only to the first region have the value 1 for their region identifier attribute. Points belonging only to the second region have the value 3 for their region identifier attribute. Points belonging to both regions have the value 2 for their region identifier attribute.

The syntax of the content of the 3D region annotation item may be in this variant:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) value_count;
    for (i=0; i < value_count; i++) {
      unsigned int(8) region_identifier_value;
    }
  }
}
```

Possibly, the 3D region annotation item may include for each region a range of values. This enables to take into account that the encoding of the region identifier attribute may be lossy. Possibly, the 3D region annotation item may include for each region one or more range of values.

Possibly, a different attribute may be used for each region. The possible values for each attribute would be a Boolean. Possibly, the default value for these attributes may be false for specifying that, by default, a point does not belong to the corresponding region. This default value may be specified using the mechanism for specifying default attribute values. This default value may also be specified by the definition of the attribute.

The syntax of the content of the 3D region annotation item may be in this variant:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    oid(v) attribute_oid;
  }
}
```

The semantic of the 3D region annotation item may be:
attribute_oid is the identification of the attribute used for defining the region. This attribute_oid field is represented using an ASN. 1 object identifier. Possibly, other representations may be used to identify the attribute used for defining the region.

Possibly, the 3D region annotation item may include for each region a list of object identifiers. This enables combining several regions. Alternatively, the object identifier may be a universally unique identifier (UUID).

Possibly, the region identifier attribute may be pre-defined attribute identified using an ‘attr_label’ from G-PCC. It may also be identified using an object identifier in G-PCC. It may also be identified using an attribute type from V3C or V-PCC.

Possibly, the identification of the regions may reuse an existing attribute, for example the opacity, the reflectance, the transparency, the material ID.

Possibly, the identification of the regions may use a new attribute that may also be used for representing another type of information. This new attribute may correspond to the kind of object a point belongs to, or to the object part a point belongs to. For example, the attribute may indicate that a point belongs to a car, or to a person. The attribute may also correspond to the object instance a point belongs to. For example, the attribute may indicate that a point belongs to a first car, or to a second car, or to a first building.

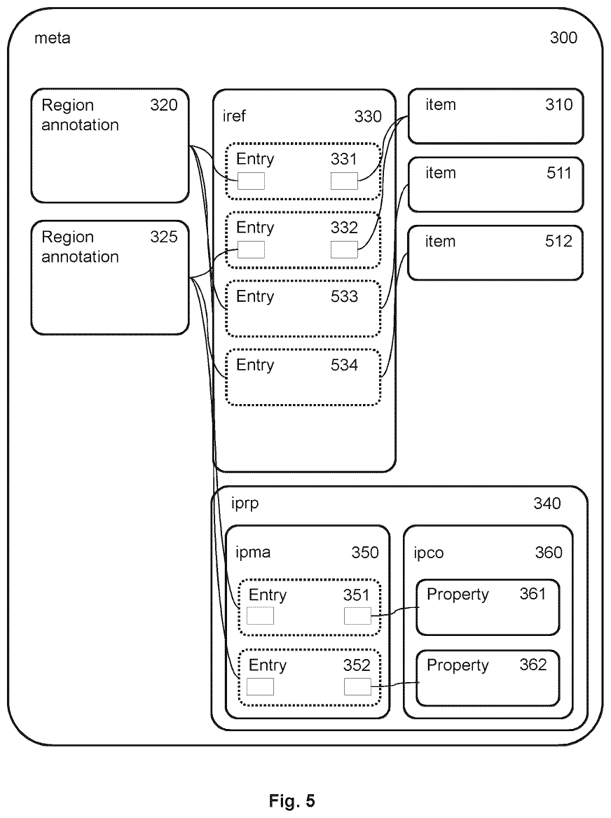

FIG. 5 illustrates a third embodiment of the invention. In this embodiment, the geometry of a region is described in another item, typically a volumetric media item. In this embodiment, the 3D region annotation item 320 is linked to the volumetric media item 511 through a reference of type ‘3drg’, 533. This reference goes from the 3D region annotation item to the volumetric media item 511. The region is defined by the volumetric media contained in the item referenced with the ‘3drg’ link from the 3D region annotation item. Possibly, the direction of the reference may be reversed. Similarly, the volumetric media item 512 defines the region corresponding to the 3D region annotation item 325.

If the volumetric media item 511 corresponds to a point cloud, for example being encoded using G-PCC or V-PCC, any point from the volumetric media item 310 located at the same position as a point from the item 511 belongs to the region corresponding to the 3D region annotation item 320.

The encoding of the geometry of volumetric media may be lossy. As a consequence, decoding the same location from the volumetric media of item 310 and from the volumetric media of item 511 may lead to slightly different values. To ensure that a point from the volumetric media of item 310 will match the corresponding point in the volumetric media of item 511, the comparison of their respective decoded locations may be realized with a tolerance. If the distance between the two locations is lower than or equal to the tolerance value, then the point from the volumetric media of item 310 is considered as belonging to the region. This tolerance may be pre-defined as an absolute value, for example 1 mm. It may be pre-defined to a fraction of the maximum dimension of the volumetric media of item 511, for example 1/1000. It may be set to the sum of the maximum position encoding error of the two volumetric media. It may also be specified inside the 3D region annotation item 320.

Using this tolerance, the region may be defined as any part of the volumetric media item 310 located in a ball with a radius equal to the tolerance value and centered on a point of the volumetric media of item 511.

If the volumetric media 511 corresponds to a visual volumetric media, for example being encoded using V3C, any part from the volumetric media item 310 located inside the volumetric media from item 511 belongs to the region corresponding to the 3D region annotation item 320.

As for a point cloud, the encoding of the geometry of volumetric media may be lossy. A tolerance may therefore be applied to the definition of the interior volume of the volumetric media 511. Using this tolerance, the region may be defined as any part inside the volume of the volumetric media 511 or within a distance from the surface of the volumetric media lower than or equal to the value of the tolerance.

A 3D region annotation item may be linked with several volumetric media items. This link may be realized with a single ‘3drg’ reference. This link may be realized with several ‘3drg’ references.

The syntax of the content of the 3D region annotation item may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(field_size) offset_x;
    unsigned int(field_size) offset_y;
    unsigned int(field_size) offset_z;
    unsigned int(field_size) tolerance;
  }
}
```

The semantic of the 3D region annotation item may be:
offset_x, offset_y, and offset_z define the relative position of the volumetric media defining the region inside the volumetric media containing the media. Possibly these fields are not present and the coordinate systems of the volumetric media defining the region and the volumetric media containing the region are directly used. Possibly these fields are optional
tolerance is the value of the tolerance for comparing the positions of points from the volumetric media defining the region and points from the volumetric media to which the region applies.
Each tolerance value corresponds to the region represented by the volumetric media item at the same position inside the list of items linked from the 3D region annotation item through a ‘3drg’ reference.

The other fields have the same semantics as in the previous embodiments.

In a variant of this embodiment, the boundary of a region may be defined by the convex hull of points from the volumetric media item referenced by the 3D region annotation item.

In a variant, the tolerance value may be used with a Manhattan-like distance: the region may be defined as any part of the volumetric media item 310 located in a cube with a size equal to the tolerance value and centered on a point of the volumetric media of item 511. Possibly, three tolerance values may be used to use rectangular cuboids instead of cubes

In a variant, an attribute from the media item 511 or 512 may be used as a confidence level for a location of the volumetric media item 310 to belong to the region. For example, the luminance value or the opacity value associated to a point of the media item 511 or 512 may be used to represent the confidence that the point is inside the region defined by the media item.

In a variant, the region annotation item 320 or 325 describes the coarse geometry of the region, using for example the geometric description described in the first embodiment, and the geometry described in the associated volumetric media item 511 or 512 provides a finer description of the geometry of the region. This finer geometry can be considered as a masking of the “coarse region” described in the region annotation item

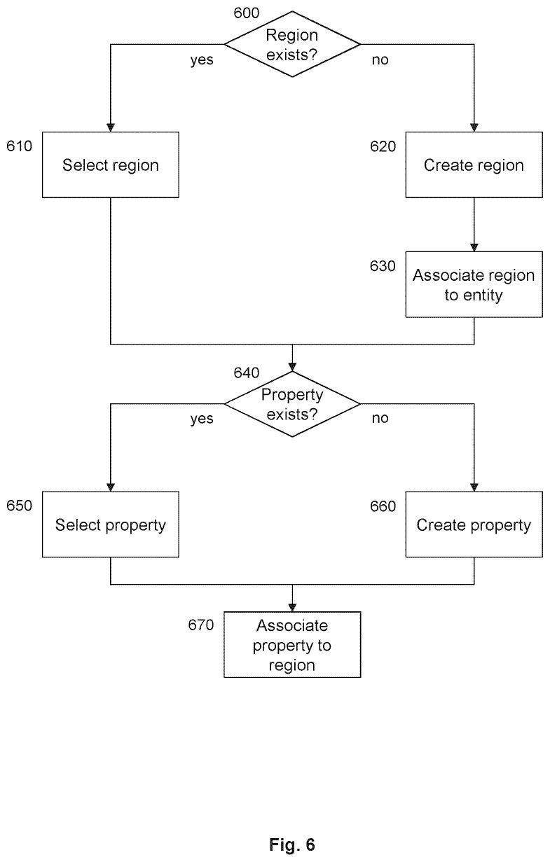

FIG. 6 illustrates the main steps of a process for adding a new 3D region annotation to a volumetric media item stored in an ISOBMFF file when the 3D region annotation is described by an item according to embodiments of the invention. These steps can be applied to an ISOBMFF file stored on a disk, stored in memory, or stored with an adapted representation in memory. The new 3D region annotation comprises the geometry of the region and the annotation itself. Possibly, these steps may be modified to add simultaneously several annotations to a region of a volumetric media item. Possibly, these steps may also be modified to add simultaneously an annotation to several regions of a volumetric media item.

This process can be used when creating a new ISOBMFF file, or when modifying an existing ISOBMFF file.

In a first step 600, it is determined whether a 3D region annotation item with the same geometry already exists in the ISOBMFF file.

If a 3D region annotation item with the same geometry already exists, the next step is step 610, otherwise, the next step is step 620.

In step 610, the item_ID value corresponding to the existing 3D region annotation item is selected. The next step is step 640.

At step 620, a new 3D region annotation item for representing the region is created. An ‘infe’ box describing the 3D region annotation item may be created inside the ‘iinf’ box of the ISOBFMM file. An entry inside the ‘iloc’ box may be added to indicate the location of the content of the 3D region annotation item. An item_ID value is associated with this new 3D region annotation item.

In the case of the first or fourth embodiment, the geometry of the region is stored inside the content of the 3D region annotation item.

In the case of the second embodiment, the value of the region identifier attribute corresponding to the region is stored inside the content of the 3D region annotation item. If the volumetric media to which the region is associated has no region identifier attribute, then the values for the region identifier attribute may be encoded and associated with the volumetric media item to which the region is associated. If the volumetric media has a region identifier attribute and if the new 3D region annotation item is associated to a new value of this region identifier attribute, then the region identifier attribute values may be decoded, they may be updated with the value corresponding to the new region for the points inside this new region, and these values may be re-encoded and associated with the volumetric media item.

In the case of the third embodiment, the tolerance associated to the region is stored inside the content of the 3D region annotation item. A new volumetric media item corresponding to the geometry of the region may be created, added to the ISOBMFF file and associated with the new 3D region annotation item.

Then, at step 630, the new 3D region annotation item is associated with the volumetric media item. A new reference of type ‘cdsc’ is created in the ‘iref’ box of the ISOBMFF file. This reference associates the 3D region annotation item with the volumetric media item.

The next step is step 640.

At step 640, it is determined whether an item property corresponding to the annotation already exists in the ISOBMFF file. If the item property already exists, the next step is step 650, otherwise, the next step is step 660.

If the annotation is stored in an item, for example if the annotation is some XMP data or if it is a 2D or 3D image, it is determined whether an item corresponding to the annotation already exists in the ISOBMFF file. If the item already exists, the next step is step 650, otherwise, the next step is step 660.

In step 650, the existing item property or item is selected.

In step 660, a new item property is created to represent the annotation. The type of the item property depends on the content of the annotation. The information contained in the annotation is stored inside the item property.

If the annotation is stored in an item, a new item is created to represent the annotation at same step 660. The type of the item depends on the content of the annotation. The information contained in the annotation is stored inside the item content, for example in the ‘mdat’.

After either step 650 or step 660, the next step is step 670.

At step 670, the item property or the item is associated with the 3D region annotation item.

If the 3D region annotation item has already an associated entry in the ‘ipma’ box, then the index of the item property is added to this entry.

If the 3D region annotation item does not have an associated entry in the ‘ipma’ box, then a new association is created for this item and the index of the item property is set to this new association.

If the annotation is stored inside an item, if an item reference with the appropriate type already exists, then the list of references is updated with a reference to this new item, otherwise, a new item reference with the appropriate type is created between the 3D region annotation item and the new item.

Possibly, if a 3D region annotation item may comprise several regions, meaning that a same annotation is associated with several different regions, several steps may be modified. At step 600, it is determined whether a 3D region annotation item comprising a single region with the same geometry exists. At step 620, it is determined whether an existing 3D region annotation item is associated with the volumetric media item with a set of properties corresponding to the annotation of the new 3D region annotation item. If this is the case, the geometry of the new region is added to the existing 3D region annotation item and steps 640 to 670 are not executed. If this is not the case, a new 3D region annotation item is created and references may be added accordingly.

In the case of the fourth embodiment, multiple item properties or items may be created at step 660 or selected at step 650.

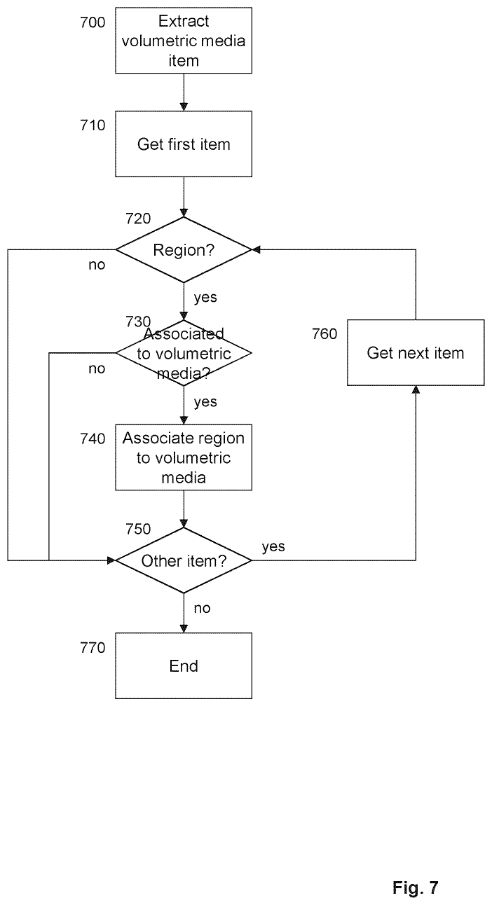

FIG. 7 illustrates the main steps of a process for reading an ISOBMFF file containing 3D region annotations when the region annotations are described by an item according to embodiments of the invention.

In a first step 700, a volumetric media item is extracted from the file. Possibly, only part of the metadata describing the volumetric media item is extracted.

In step 710, a first item, different from the volumetric media item, is extracted from the file. If no other items exist in the file, the algorithm continues directly at step 770.

Then, in step 720, it is determined whether the other item is a 3D region annotation item. If it is a 3D region annotation item, the next step is step 730, otherwise, the next step is step 750.

At step 730, it is determined whether the 3D region annotation item is associated with the volumetric media item by a reference of type ‘cdsc’ inside the ‘iref’ box. If this is the case, the next step is step 740, otherwise the next step is step 750.

At step 740, the item properties associated with the 3D region annotation item through an entry of the ‘ipma’ box are extracted. The items associated with the region annotation item are also extracted. Possibly only item properties or items are associated with the 3D region annotation item are extracted, or none of them.

Then the geometry of the 3D region annotation item is extracted.

In the context of the first or the fourth embodiment, the geometry is extracted from the content of the 3D region annotation item.

In the context of the second embodiment, the value of the region identifier attribute corresponding to the region is extracted from the 3D region annotation item. Then the points from the volumetric media item whose region identifier attribute value matches this extracted value are extracted. These extracted points define the geometry of the region.

In the context of the third embodiment, the items referenced from the 3D region annotation item through a ‘3drg’ reference are extracted. These items define the geometry of the region.

The region with the extracted item properties and with the extracted items is associated with the volumetric media item. The information contained in the item properties or in the items may be extracted and associated with the geometry of the region to the volumetric media item.

If the 3D region annotation item comprises several regions, then each of these regions with the extracted item properties and with the extracted items is associated with the volumetric media item. The information contained in the item properties or in the items may be extracted and associated with the geometry of each of these regions to the volumetric media item.

The next step is step 750.

At step 750, it is determined whether there are other items different from the volumetric media item in the ISOBMFF file. If this is the case, the next step is step 760, otherwise, the next step is step 770.

At step 760, another item is extracted from the ISOBMFF file. The next step is step 720.

At step 770, the process ends.

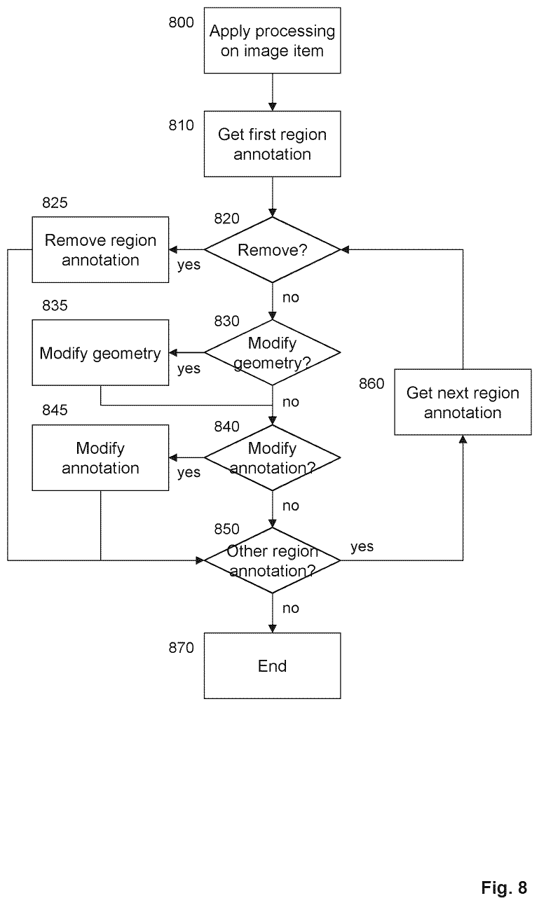

FIG. 8 illustrates a process for processing an ISOBMFF file containing a volumetric media and one or more 3D region annotation items associated with this volumetric media according to embodiments of the invention. The process may be a volumetric media rendering process. The process may be a volumetric media editing process. It may be a process changing the content of the volumetric media such as applying a filter or drawing on the volumetric media. The process may be a metadata edition process. It may be a process for removing private metadata. It may be a process for filtering metadata. It may be a process for translating metadata, or any other process manipulating the file.

In the first step 800, the process is applied on the volumetric media item. Possibly the volumetric media associated with the volumetric media item may be modified.

Possibly the result of the process may be stored in another volumetric media item as a derived volumetric media item. In this case, 3D region annotation items associated with the original volumetric media item may also be associated with this derived volumetric media item. If the result of the process is stored as a derived volumetric media item, then, in the following steps, the processed volumetric media item is the derived volumetric media item.

In the step 810, a first region annotation associated with the processed volumetric media item is retrieved. If no region annotation is associated with the processed volumetric media item, the next step is the step 870.

In the step 820, it is determined whether the region annotation should be removed. Depending on the process, different criteria may be used. A process may remove all region annotations. A process may remove any region annotation with a specific type. For example, a privacy preserving filter may remove any region annotation represented by a user defined item property. A process may remove a region annotation depending on its localization.

If it is determined that the region annotation is to be removed, the next step is step 825. Otherwise the next step is step 830.

In step 825, the region annotation is removed. The next step is step 850.

In step 830, it is determined whether the region annotation's geometry should be modified. Any process transforming the geometry of the volumetric media should also modify in an appropriate way the region annotation's geometry.

If it is determined that the region annotation's geometry should be modified, the next step is step 835. Otherwise, the next step is step 840.

In step 835, the geometry of the region annotation is modified according to the process. Possibly the modified geometry is the exact result of applying the geometry transformation to the geometry of the region annotation. Possibly the modified geometry is an approximate result of applying the geometry transformation to the geometry of the region annotation.

The next step is step 840.

In step 840, it is determined whether the annotation of the region annotation should be modified. Depending on the process different criteria may be used. A process translating textual annotation may modify the text representing the annotation. A process filtering the volumetric media, for example by applying a blur, may modify the annotation to remove precise parts from it.

If it is determined that the annotation of the region annotation should be modified, the next step is step 845. Otherwise, the next step is step 850.

In step 845, the annotation of the region annotation is modified according to the process.

For example, in FIG. 2b, the region 261 has a region annotation corresponding to the description of a person. A privacy preserving process may keep the indication that the region annotation corresponds to a person but may remove the name of the person. The next step is step 850.

In step 850, it is determined whether there are other region annotations to process. If it is determined that there are other region annotations to process, the next step is step 860. Otherwise, the next step is step 870.

In step 860, another region annotation associated with the volumetric media item is retrieved. The next step is step 820.

In step 870, the process ends.

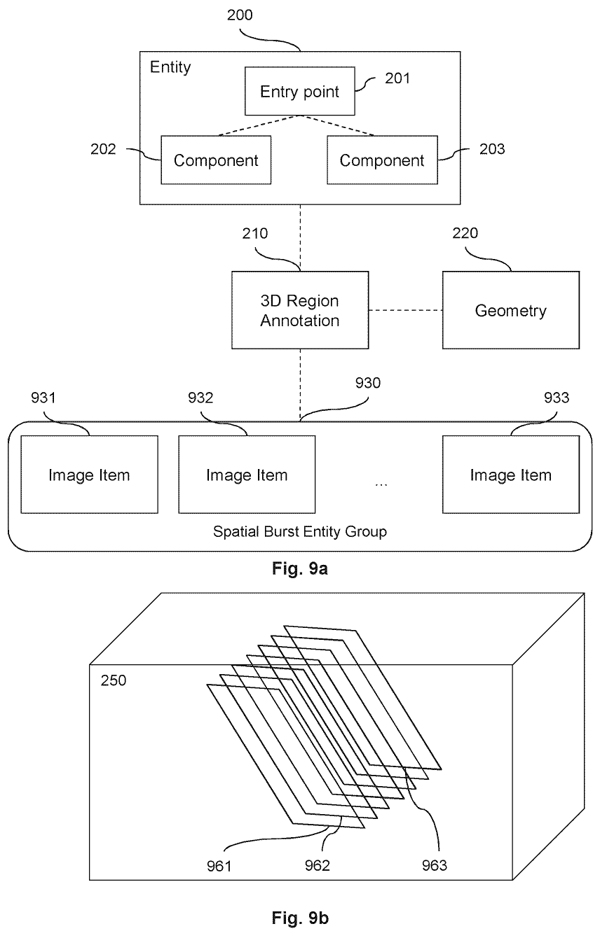

FIG. 9a and FIG. 9b illustrates a fourth embodiment of the invention. In this embodiment, the content of the annotation may be split into several chunks. For example, the annotation may be a burst of CT (Computed Tomography) or MRI (Magnetic Resonance Imaging) images associated to a volumetric media item. In this embodiment, the 3D region annotation item 210 may be associated with the entity group 930 describing the content of the region. This association may be realized using an item reference of type ‘eroi’ from the 3D region annotation item 210 to the entity group 930. The entity group 930 may be of type ‘sbst’ to denote a spatial burst of images. An entity group of type ‘sbst’, called a spatial burst of images, groups entities that are related through a spatial location. The entity group contains the image items that are part of the spatial burst, including the image items 931, 932 and 933.

In a spatial burst of images there is no specific timing information on the entities contained in the group. For example a spatial burst of images may be cross sections of an object captured at regular spatial intervals such as CT or MRI images. It may also be images captured at regular distance intervals on a path on which the sensor moves. It may also be videos of cross sections of an object captured at regular spatial intervals.

The geometry of the 3D region corresponding to the 3D region annotation item 210 may be composed of a set of geometries, each geometry of the set corresponding to a chunk of the annotation content. For example, in FIG. 9b, the geometry of the region is represented as a set of planes: plane 961, plane 962, . . . , plane 963. Each image item contained in the entity group 930 correspond to a chunk of the annotation content. Plane 961 may be associated to the image item 931, plane 962 may be associated to the image item 932 and so on.

The syntax of the content of a 3D region annotation item may be, expressed as an extension of the syntax used for the first embodiment:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) geometry_type;
    . . .
    if (geometry_type == 5) {
      // Volume as a discrete set of planes
      unsigned int(8) plane_count;
      unsigned int(field_size) plane_gap;
      signed int(field_size) x;
      signed int(field_size) y;
      signed int(field_size) z;
      signed int(field_size) normal_x;
      signed int(field_size) normal_y;
      signed int(field_size) normal_z;
    }
  }
}
```

The semantics of the 3D region annotation item may be:
x, y, z are fixed point decimals specifying the coordinates of a point in the reference plane.
normal_x, normal_y, normal_z are fixed point decimals specifying a normal vector of the reference plane.
plane_count is the number of planes in the set of planes.
plane_gap is the distance between two planes in the set.

The other fields have the same meaning as in the first embodiment.

For a set of planes, the first plane is the reference plane. Then each plane is at a distance “plane_gap” from the previous plane in the direction of the normal vector.

Possibly, the x, y, z fields may specify a point at the centre of the set of planes and not on the reference plane.

In this embodiment, each plane is associated with an image item from the entity group 930. The planes may be ordered inside the set of planes starting with the reference plane. The image items contained in the entity group 930 may be ordered inside the entity group according to their listing order inside the definition of the entity group. The plane ordered at index i may be associated with the image item ordered at index i.

In this embodiment, other set of geometries may be used, for example a set of circles or a set of rectangular cuboids. Other types of items or entities may be associated with the set of geometries, for example an entity group grouping volumetric media items, an entity group grouping audio tracks, an entity group grouping auto exposure bracketing groups. Possibly a set of geometries may be associated with a set of properties, for example the 3D region annotation item may have several associated ‘udes’ item properties, each one corresponding to a geometry inside its set of geometries.

In a variant of this embodiment, the spatial burst entity group 930 is associated directly with the entity 200, for example using an item reference of type ‘3drg’ or of type ‘eroi’. In this variant, the geometry of the region from entity 200 associated with an item contained in the entity group 930 may be specified inside an item property associated with the item. The geometry of the regions from entity 200 associated with the items contained in the entity group 930 may also be specified inside an item associated with the entity group or inside an item property associated with the entity group.

Possibly, any type of annotation may be associated directly with the entity 200, for example using an item reference of type ‘3drg’ or of type ‘eroi’. In this variant, the geometry of the region from entity 200 associated with an item contained in the entity group 930 may be specified inside an item property associated with the item.

FIG. 10 illustrates a fifth embodiment for annotating regions in a volumetric media track. In this embodiment, annotations are stored in the ‘meta’ part of a media file 1001 while the track description is within the ‘moov’ part of the media file 1000. In this embodiment, the media file is augmented with regions annotations whose annotations are stored within the file-level ‘meta’ box 1001.

In this embodiment, the volumetric media is stored as a track 1000-1. The geometries of the regions may be stored in a timed metadata track 1000-2 as samples 1000x. The timed metadata track 1000-2 may be associated with the volumetric media track 1000-1 using a track reference type set to ‘cdsc’ (for content description). This timed metadata track may be called the region annotation track.

Optionally, the timed metadata track may also be associated with another volumetric media track 1000-3, or a video or image sequence track or an audio track providing a description of the region of interest described in this timed metadata track. This may be indicated by the ‘eroi’ track reference type.

The timed metadata track comprising the samples containing the geometry of the regions may be identified with a sample entry with a specific four-character code, e.g. ‘3dan’. In an alternative or in addition to the new sample entry type, a specific track reference may also be used between the timed metadata track 1000-2 and the volumetric media track 1000-1. For example, instead of using the generic ‘cdsc’ track reference, a track reference type set to ‘3dan’ for “3D region annotation” can be used between a timed metadata track 1000-2 and the volumetric media track 1000-1 from which the region has been identified or extracted.

The specific track reference type may help a media file reader in interpreting the timed metadata track 1000-2.

The geometry of a region may be stored inside a sample of the timed metadata track 1000-2 using the same syntax as any of the previous embodiments. Possibly, the fields corresponding to the reference_size for the region annotation may be stored in a sample entry box instead of being stored inside the samples themselves. They may also be defined as a data structure like 3DPoint or Vector3D providing x,y,z coordinates. The syntax of such a sample entry may be:

```
aligned(8) class 3DRegionTrackConfigBox ( ) extends FullBox (′3rgC′,
version=0, flags=0) {
  unsigned int (7) reserved = 0;
  unsigned int (1) field_length_size;
  unsigned int((field_length_size + 1) * 16) reference_size_x;
  unsigned int((field_length_size + 1) * 16) reference_size_y;
  unsigned int((field_length_size + 1) * 16) reference_size_z;
}
aligned(8) class RegionSampleEntry
extends MetadataSampleEntry ( ′3dan′ ) {
  3DRegionTrackConfigBox config; // mandatory
}
```

Similarly to the third embodiment, the volumetric media defining the geometry of a region may be stored into a track and associated with the region annotation track 1000-2 using a track reference of type ‘3drg’. The volumetric media may also be stored in an item (not represented) and associated with the region annotation track 1000-2 using a sample grouping providing SampleToMetadataltemEntry (from ISOBMFF specification).

It is to be noted that the timed metadata track 1000-2 may contain less samples than the volumetric media track 1000-1 it describes. For example, when the region of interest's position and size remain stable along time or when the position or size may be interpolated, there may be no sample 1000x corresponding to a volumetric media sample.

In a first variant, region annotations are declared as item properties of type ‘udes’ (for example in the ItemPropertyContainerBox ‘ipco’ 1002), and the track 1000-2 providing the region geometries contains a sample grouping 1040 providing SampleToMetadataItemEntry (from ISOBMFF specification). In other words, groups of 2dcc samples from the track 1000-2 may be associated with one or more item property of type ‘udes’, as illustrated by the arrows 1020 or 1030. The item_ID in the SampleToMetadataItemEntry is set to the implicit ID of the property in the ‘ipco’ container box 1002. Indeed, the ‘ipco’ box implicitly defines an identifier that corresponds to the position of an item property in the ‘ipco’ box. Several groups of samples may be linked to a same item property providing an annotation for a region. Some item properties providing annotations or user descriptions may not be referenced by samples from the timed metadata track 1000-2 (for example, because they are used for other volumetric media items also declared in the media file). The sample grouping 1040 may be a default grouping when all the samples describing the geometry of a region have the same annotation.

In a second variant, to explicitly indicate that the IDs used in the sample group entries 1040 correspond to identifiers of item property, a new grouping type is defined to indicate that samples are actually associated not to items but explicitly to item properties. The syntax of this new grouping type may be as follows (the 4cc and the name of the sample group entry are here as an example):

```
class SampleToItemPropertyEntry( )
extends SampleGroupDescriptionEntry(′stip′) {
  unsigned int (32) property_type;
  unsigned int (32) meta_box_handler_type;
  unsigned int (32) num_properties counts;
  for(i = 0; i < num_properties counts; i++) {
    unsigned int(32) property_index[i] ;
  }
}
```

The property_type is an optional parameter indicating the 4cc corresponding to the type of property to which samples are associated. When present, the property_index may count only properties of the specified type. When not present (or by default), the property_index is the 1-based index (counting all boxes, including FreeSpace boxes) of the associated property box in the ItemPropertyContainerBox 1002 contained in the same ItemPropertiesBox. The value 0 may be reserved, for example to indicate no association with any property. This can be signalled by not mapping samples or NAL units to a property.

The meta_box_handler_type may specify the type of metadata schema used by the MetaBox which is referenced by the items in this sample group.

When there are multiple MetaBoxes with the same handler type, the MetaBox referred to in this sample group entry is the first MetaBox fulfilling one of the following ordered constraints:
A MetaBox included in the current track, with handler_type equal to meta_box_handler_type.
A MetaBox included in MovieBox, with handler_type equal to meta_box_handler_type.
A MetaBox included in the root level of the file, with handler_type equal to meta_box_handler_type.

num_properties counts the number of item properties referenced by this sample group.

property_index [i] specifies the 1-based index (counting all boxes, including FreeSpace boxes) of an item property box, in the ItemPropertyContainerBox contained in the ItemPropertiesBox, that applies to or is valid for the sample mapped to this sample group description entry.

In a third variant, annotations may be stored in another media stored in a track (e.g., ROI volumetric media track 1000-3). It may be a volumetric media track, a video track, a metadata track or an audio track. The relationship between the timed metadata track 1000-2 describing the geometries of the regions and this track 1000-3 may use a track reference of type ‘eroi’.

All the embodiments and variants described in relation with items may also apply to tracks based on this fifth embodiment.

An annotation may correspond to an object detected inside a volumetric media by an object detection tool. It may be represented using a user description item property, for example using a specific value for the name field and/or for the tags field, and/or using a more descriptive value for the description field. For example, the name field may be “building” and the description field may be “House, building or monument”. It may be represented by a new item property.

An annotation may correspond to a specific object instance detected inside a volumetric media by an object detection tool. It may be represented using a user description item property, for example using a specific value for describing the generic type of the object in the tags field, using a more precise value corresponding to the object instance in the name field, and/or using descriptive value for the object instance in the description field. For example the tags field may be “church”, the name field may be “Notre Dame” and the description field may be “Notre Dame de Paris”. It may be represented by a new item property.

An annotation may be a GPS location for an object in the volumetric media. It may be represented by a new item property. For example:

```
aligned(8) class ItemGPSLocationProperty
extends ItemFullProperty(′igps′, version = 0, flags = 0) {
  signed int(32) viewpoint_gpspos_longitude;
  signed int(32) viewpoint_gpspos_latitude;
  signed int(32) viewpoint_gpspos_altitude;
}
```

where
viewpoint_gpspos_longitude indicates the longitude of the geolocation of the viewpoint in units of 2-23 degrees. viewpoint_gpspos_longitude shall be in range of −180*223 to 180*223−1, inclusive. Positive values represent eastern longitude and negative values represent western longitude.
viewpoint_gpspos_latitude indicates the latitude of the geolocation of the viewpoint in units of 2-23 degrees. viewpoint_gpspos_latitude shall be in range of −90*223 to 90*223−1, inclusive. Positive value represents northern latitude and negative value represents southern latitude.
viewpoint_gpspos_altitude indicates the altitude of the geolocation of the viewpoint in units of milimeters above the WGS 84 reference ellipsoid as specified in the EPSG: 4326 database.

It is to be noted that this property may be associated to image or volumetric items as well to indicate where the image or volumetric data was captured.

An annotation may describe an edition or a modification applied to a region of a volumetric media. It may be represented by a user description item property. It may be represented by a new item property.

An annotation may be stored in an item. This item may be associated with a 3D region annotation item by a reference of type ‘cdsc’. This item may be associated with a 3D region annotation item property through a new item property associated to the 3D region annotation item and referencing this item. The box type of this new item property may be ‘rgcd’. For example, an annotation may be stored in an item of type ‘Exif’. As another example, an annotation may be stored in an XMP document contained in an item of type ‘mime’ and with content type ‘application/rdf+xml’.

An annotation may be another media stored in an item. It may be another volumetric media item, it may be an image item. An annotation may be an entity group. An annotation may be another media stored in a track. It may be a volumetric media track, a video track or an audio track. The relationship between the region and the other media stored in an item or in a track may be specified through the association between the 3D region annotation item and the other item or track. For example, the relation between the region and an item or an entity group may use an item reference of type ‘eroi’.

Possibly, when using a user description item property, the language field is set to an appropriate value. Possibly, when using a user description item property, several instances of this item property are used with different language field values.

In all the embodiments, some fields may be removed or renamed, and some fields may be added. Some parameters, for example x, y, z may be gathered in a data structure and replaced by this data structure, e.g. 3DPoint or Vector3D.

In all the embodiments, encoding of one or more fields may be changed. In particular, the size of a field and/or its type may be changed.

In all the embodiments, the 4cc used may have different names or re-use existing names if appropriate.

The coordinates of a region may be expressed using different reference systems. They may use the external coordinate of the volumetric media the region is associated with. They may use the coding coordinate of the volumetric media the region is associated with. They may use another coordinate system associated with the volumetric media.

The coordinates of a region may use another coordinate system defined in reference with one of those systems. This coordinate system may be specified using a transformation from or to one of the coordinate systems associated with the volumetric media. This transformation may include a translation, a rotation, a scaling, or any other affine transformation.

Possibly, the 3D region annotation item may include some fields for indicating which coordinate system is used and/or which transformation from or to this coordinate system is used.

Possibly the same coordinate system may be used for all the regions described in a 3D region annotation item. Possibly different coordinate systems may be used for the different regions described in a 3D region annotation item.

Possibly the coordinates of a region may be specified relatively to a part of the volumetric media it is associated with. For example, it may be specified relatively to a tile or a slice of the volumetric media.

Possibly the coordinates of a region may be specified relatively to a part of another volumetric media.

For this variant, the syntax of the 3D region annotation item may be updated as follows:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) geometry_type;
    unsigned int(1) entity_relative;
    unsigned int(1) slice_relative;
    unsigned int(1) tile_relative;
    unsigned int(5) reserved;
    if (entity_relative == 1) {
      unsigned int(8) entity_id;
    }
    if (slice_relative == 1) {
      unsigned int(8) slice_id;
    }
    if (tile_relative == 1) {
      unsigned int(8) tile_id;
    }
    . . .
  }
}
```

The semantics of this variant of the 3D region annotation item may be:
item_relative set to true indicates that the coordinates of the region are relative to the coordinates of the entity indicated by entity_id. Otherwise, the coordinates of the region are expressed using the global coordinate system.
slice_relative set to true indicates that the coordinates of the region are relative to the bounding box of the slice indicated by slice_id. Otherwise, the coordinates of the region are expressed using the global coordinate system.
tile_relative set to true indicates that the coordinates of the region are relative to the bounding box of the tile indicated by tile_id. Otherwise, the coordinates of the region are expressed using the global coordinate system.

Possibly, only slice relative coordinates or tile relative coordinates may be included in the 3D region annotation item.

Possibly, the slice and tile related fields may be common to all the regions of a 3D region annotation item.

In the case of the third embodiment, the same coordinate systems may be used for both the annotated item 310 and the volumetric media defining the annotated region 511 or 512. Possibly different coordinates system may be used and may be specified inside the 3D region annotation item 320 or 325. Possibly, a transformation between the coordinate system of the annotated item 310 and those of the volumetric media items 511 or 512 may be specified respectively inside the 3D region annotation items 320 or 325.

Possibly the coordinates of a region may be specified as integers, as floats, as fixed point decimals. Possibly the type used for the coordinates may be specified inside a 3D region annotation item.

The reference_size parameters are optional. They may provide the original size of a volumetric media that has been edited. They may help using a region annotation associated with a volumetric media that has been edited.

The field_size parameter is optional. The size of the fields depending on the field_size parameter may be pre-defined. The size of the fields depending on the field_size parameter may be dependent only on a version of the box describing the region annotation.

The orientation of a region may be specified as a quaternion. Possibly only the x, y, z values of the quaternion may be specified, the w value of the quaternion being computed as:

$$w = \sqrt{1 - {x}^{2} - {y}^{2} - {z}^{2}}$$

Possibly, the orientation of a region may be specified as a vector and an angle. Possibly, the orientation of a region may be specified as two vectors. Possibly, the orientation of a region may be specified as a matrix. Possibly, the orientation of a region may be specified as three angles corresponding to roll, pitch and yaw.

Possibly, the orientation may not be defined. Possibly, the orientation may be defined in a simpler manner.

Possible, the orientation of a region may be specified by listing at least four points corresponding to vertices of a rectangular cuboid or to vertices of the bounding box of an ellipsoid.

Possibly, a rectangular cuboid or an ellipsoid may be specified as.
a point defining the centre of the rectangular cuboid or of the ellipsoid.
A first vector defining the ‘width’ direction and dimension of the rectangular cuboid or ellipsoid.
A second vector defining the ‘length’ direction and dimension of the rectangular cuboid or ellipsoid.
The ‘height’ dimension of the rectangular cuboid or ellipsoid.

Possibly, a plane may be bounded. It dimensions may be specified by a vector defining a first direction, a length along this direction and a width along the perpendicular direction. It dimensions may also be specified by a vector defining a first direction and the length along this direction, and by a width along the perpendicular direction.

Other geometries for a region may be defined such as a pyramid with a polygon as a base and a summit, a cylinder, the extrusion of a flat shape, a triangle mesh, a platonic solid . . . . The geometry of a region may also be a 2 dimensional shape.

Possibly, the geometry of a region may be defined as a combination of geometries using constructive solid geometry. Possible combinations may include the union, the difference or the intersection of two shapes.

In a variant of the first embodiment using constructive geometry operations, the syntax of the 3D region annotation item may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(1) is_region;
    unsgiend int(7) reserved;
    unsigned int(8) geometry_type;
    if (geometry_type == 0) {
      // point
      . . .
    }
    if (geometry_type == 1) {
      // polyline
      . . .
      }
    }
    if (geometry_type == 2) {
      // plane
      . . .
    }
    if (geometry_type == 3) {
      // rectangular cuboid
      . . .
    }
    if (geometry_type == 4) {
      // ellipsoid
      . . .
    }
    if (geometry_type == 5) {
      // union
      unsigned int(8) first_geometry_index;
      unsigned int(8) second_geometry_index;
    }
    if (geometry_type == 6) {
      // intersection
      unsigned int(8) first_geometry_index;
      unsigned int(8) second_geometry_index;
    }
    if (geometry_type == 7) {
      // difference
      unsigned int(8) first_geometry_index;
      unsigned int(8) second_geometry_index;
    }
  }
}
```

The semantics of this 3D region annotation item may be:
is_region indicates whether the geometry correspond to a region of the volumetric media or if it is only used in the construction of a region.
first_geometry_index and second_geometry_index indicates the indexes inside the list of regions of the geometries combined by a constructive solid geometry operation. In the case of a union, the resulting geometry is the union of the two indicated geometries. In the case of an intersection, the resulting geometry is the intersection of the two indicated geometries. In the case of a difference, the resulting geometry is the difference between the first geometry and the second geometry. Possibly, the first, the second or both indicated geometries may correspond to the result of another constructive solid geometry operation.

In this variant, the different operations may combine more than two geometries.

This variant may also be used with the other embodiments.

In a variant of the third embodiments, entity groups may be defined for combining volumetric media using constructive geometry operations. For instance, a geometry union entity group of type ‘geou’ may be used to define the geometry of a region as the union of two or more other geometries, either volumetric media items or constructive geometry operation entity groups. Similarly a geometry intersection entity group of type ‘geoi’ may be defined and a geometry difference entity group of type ‘geod’ may be defined.

Possible two or more of the previously described embodiments may be combined. This combination may be realized by indicating the usage of the second or the third embodiments through specific values of the geometry_type field.

Possibly, the first and second embodiments may be combined to define a region using jointly a geometric shape and an attribute value: the region may be defined as all the points whose region identifier value matches the value defined for the region and that are inside the geometric shape of the region.

For example, the syntax of the content of a 3D region annotation item or entity combining the first and second embodiments may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) geometry_type;
    if (geometry_type == 0) {
      // point
      signed int(field_size) x;
      signed int(field_size) y;
      signed int(field_size) z;
    }
    if (geometry_type == 1) {
      // polyline
      unsigned int(field_size) point_count;
      for (i=0; i < point_count; i++) {
        signed int(field_size) x;
        signed int(field_size) y;
        signed int(field_size) z;
      }
    }
    if (geometry_type == 2) {
      // plane
    unsigned int(field_size) point_count;
    for (i=0; i < point_count; i++) {
      signed int(field_size) x;
      signed int(field_size) y;
      signed int(field_size) z;
      signed int(field_size) normal_x;
      signed int(field_size) normal_y;
      signed int(field_size) normal_z;
    }
  }
  if (geometry_type == 3) {
    // rectangular cuboid
    signed int(field_size) x;
    signed int(field_size) y;
    signed int(field_size) z;
    signed int(field_size) size_x;
    signed int(field_size) size_y;
    signed int(field_size) size_z;
    signed int(field_size) quaternion_w;
    signed int(field_size) quaternion_x;
    signed int(field_size) quaternion_y;
    signed int(field_size) quaternion_z;
  }
  if (geometry_type == 4) {
    // ellipsoid
    signed int(field_size) x;
    signed int(field_size) y;
    signed int(field_size) z;
    signed int(field_size) size_x;
    signed int(field_size) size_y;
    signed int(field_size) size_z;
    signed int(field_size) quaternion_w;
    signed int(field_size) quaternion_x;
    signed int(field_size) quaternion_y;
    signed int(field_size) quaternion_z;
  }
  if (geometry_type == 5) {
    // region defined by an attribute
    signed int(field_size) x;
    signed int(field_size) y;
    signed int(field_size) z;
    signed int(field_size) size_x;
    signed int(field_size) size_y;
    signed int(field_size) size_z;
    unsigned int(8) region_identifier_value;
  }
  }
}
```

The semantic of the 3D region annotation item may be:
For the geometry_type 5, the x, y, z and size_x, size_y, size_z fields define the bounding box of the region as a rectangular cuboid aligned on the axes of the coordinate system. The region_identifier_value is the value of the region identifier attribute of the points of the volumetric media contained in the region.
Possibly rotation information may be added to the description of the bounding box of the region in the case of the geometry_type 5, for example using a quaternion.

Possibly, the first and third embodiments may be combined to restrict the geometry defined by a volumetric media to a geometric shape specified for the region. This combination may be viewed as a crop of the volumetric media.

For example, the syntax of the content of a 3D region annotation item or entity combining the first and second embodiments may be:

```
aligned (8) class 3DRegionItem {
  unsigned int(8) version = 0;
  unsigned int(8) flags;
  unsigned int field_size = ((flags & 1) + 1) * 16; // this is a
temporary, non-parsable variable
  unsigned int(field_size) reference_size_x;
  unsigned int(field_size) reference_size_y;
  unsigned int(field_size) reference_size_z;
  unsigned int(8) region_count;
  for (r=0; r < region_count; r++) {
    unsigned int(8) geometry_type;
    if (geometry_type == 0) {
    // point
    signed int(field_size) x;
    signed int(field_size) y;
    signed int(field_size) z;
  }
  if (geometry_type == 1) {
    // polyline
    unsigned int(field_size) point_count;
    for (i=0; i < point_count; i++) {
      signed int(field_size) x;
      signed int(field_size) y;
      signed int(field_size) z;
    }
  }
  if (geometry_type == 2) {
    // plane
    unsigned int(field_size) point_count;
    for (i=0; i < point_count; i++) {
      signed int(field_size) x;
      signed int(field_size) y;
      signed int(field_size) z;
      signed int(field_size) normal_x;
      signed int(field_size) normal_y;
      signed int(field_size) normal_z;
    }
  }
  if (geometry_type == 3) {
    // rectangular cuboid
    signed int(field_size) x;
    signed int(field_size) y;
    signed int(field_size) z;
    signed int(field_size) size_x;
    signed int(field_size) size_y;
    signed int(field_size) size_z;
    signed int(field_size) quaternion_w;
    signed int(field_size) quaternion_x;
    signed int(field_size) quaternion_y;
    signed int(field_size) quaternion_z;
  }
  if (geometry_type == 4) {
    // ellipsoid
    signed int(field_size) x;
    signed int(field_size) y;
    signed int(field_size) z;
    signed int(field_size) size_x;
    signed int(field_size) size_y;
    signed int(field_size) size_z;
    signed int(field_size) quaternion_w;
    signed int(field_size) quaternion_x;
    signed int(field_size) quaternion_y;
    signed int(field_size) quaternion_z;
  }
  if (geometry_type == 5) {
    // region defined by another item
    unsigned int(field_size) offset_x;
    unsigned int(field_size) offset_y;
    unsigned int(field_size) offset_z;
    unsigned int(field_size) tolerance;
  }
  }
}
```

The semantic of the 3D region annotation item or entity may be similar to those described in previous embodiments.

Possibly, the second and third embodiments may be combined to enable a single volumetric media to define several regions. A region may be defined by the point of the volumetric media associated to the 3D region annotation item whose region identifier value matches the value defined for the region inside the 3D region annotation item.

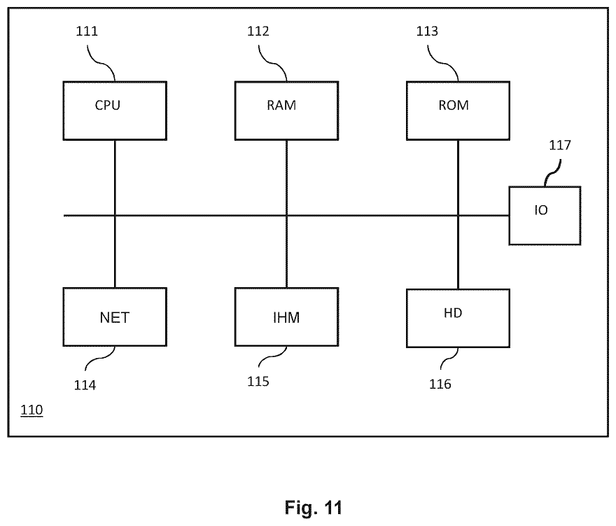

FIG. 11 is a schematic block diagram of a computing device 110 for implementation of one or more embodiments of the invention. The computing device 110 may be a device such as a microcomputer, a workstation or a light portable device. The computing device 110 comprises a communication bus connected to:
a central processing unit 111, such as a microprocessor, denoted CPU;
a random access memory 112, denoted RAM, for storing the executable code of the method of embodiments of the invention as well as the registers adapted to record variables and parameters necessary for implementing the method according to embodiments of the invention, the memory capacity thereof can be expanded by an optional RAM connected to an expansion port, for example;
a read-only memory 113, denoted ROM, for storing computer programs for implementing embodiments of the invention;
a network interface 114 is typically connected to a communication network over which digital data to be processed are transmitted or received. The network interface 114 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 111;
a user interface 115 may be used for receiving inputs from a user or to display information to a user;
a hard disk 116 denoted HD may be provided as a mass storage device;
an I/O module 117 may be used for receiving/sending data from/to external devices such as a video source or display.

The executable code may be stored either in read only memory 113, on the hard disk 116 or on a removable digital medium such as for example a disk. According to a variant, the executable code of the programs can be received by means of a communication network, via the network interface 114, in order to be stored in one of the storage means of the communication device 110, such as the hard disk 116, before being executed.

The central processing unit 111 is adapted to control and direct the execution of the instructions or portions of software code of the program or programs according to embodiments of the invention, which instructions are stored in one of the aforementioned storage means. After powering on, the CPU 111 is capable of executing instructions from main RAM memory 112 relating to a software application after those instructions have been loaded from the program ROM 113 or the hard disk (HD) 116 for example. Such a software application, when executed by the CPU 111, causes the steps of the flowcharts of the invention to be performed.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating volumetric media in a file, the method comprising:
generating a volumetric media entity describing the volumetric media;
generating a 3D region annotation entity related to a region of the volumetric media, the 3D region annotation entity being associated with the volumetric media entity;
generating geometry data associated with the 3D region annotation entity and describing the geometry of a region of the volumetric media;
generating at least one annotation data structure associated with the 3D region annotation entity; and
embedding the volumetric media entity, the 3D region annotation entity, the geometry data and the at least one annotation data structure in the file.

2. The method of claim 1, wherein:
the volumetric media entity is a first item;
the 3D region annotation entity is a second item; and
the geometry data is associated with the second item.

3. The method of claim 2, wherein the at least one annotation data structure is a property of the second item.

4. The method of claim 2, wherein the at least one annotation data structure is an item associated with the second item.

5. The method of claim 2, wherein the geometry data is comprised in the second item.

6. The method of claim 2, wherein the geometry data is comprised within the first item.

7. The method of claim 6, wherein the geometry data is determined from an identifier associated with points of the volumetric media.

8. The method of claim 2, wherein the geometry data is a third item.

9. The method of claim 2, wherein the at least one annotation data structure is a group of at least one item.

10. The method of claim 9, wherein the at least one item represents a plane within the volumetric media.

11. The method of claim 1, wherein:
the volumetric media entity is a volumetric media track and the volumetric media is comprised in a sample of the volumetric media track;
the 3D region annotation entity is a 3D region annotation track; and
the geometry data is comprised in a sample of the 3D region annotation track.

12. The method of claim 1, wherein:
the volumetric media entity is a volumetric media track and the volumetric media is comprised in a sample of the volumetric media track;
the 3D region annotation entity is a 3D region annotation track; and
the geometry data is comprised in a sample of another track associated with the 3D region annotation track.

13. The method of claim 11, wherein the at least one annotation is an item property associated with a group of samples of the 3D region annotation track.

14. The method of claim 11, wherein the 3D region annotation track is associated with a track providing a representation of the region of interest described in the 3D region annotation track.

15. A method for reading a file comprising volumetric media, the method comprising:
reading a volumetric media entity describing the volumetric media for obtaining the volumetric media;
reading a 3D region annotation entity related to a region of the volumetric media, the 3D region annotation entity being associated with the volumetric media entity;
reading geometry data associated with the 3D region annotation entity and describing the geometry of a region of the volumetric media;
reading at least one annotation data structure associated with the 3D region annotation entity for obtaining annotation data; and
processing the obtained volumetric media and the obtained at least one annotation data in function of the geometry of the region of the volumetric media.

16. (canceled)

17. A non-transitory computer-readable storage medium storing instructions of a computer program for implementing a method according to claim 1.

18. (canceled)

19. A device for encapsulating volumetric media in a file, the device comprising a processor configured for:
generating a volumetric media entity describing the volumetric media;
generating a 3D region annotation entity related to a region of the volumetric media, the 3D region annotation entity being associated with the volumetric media entity;
generating geometry data associated with the 3D region annotation entity and describing the geometry of a region of the volumetric media;
generating at least one annotation data structure associated with the 3D region annotation entity; and
embedding the volumetric media entity, the 3D region annotation entity, the geometry data and the at least one annotation data structure in the file.

20. A device for reading a file comprising volumetric media, the device comprising a processor configured for:
reading a volumetric media entity describing the volumetric media for obtaining the volumetric media;
reading a 3D region annotation entity related to a region of the volumetric media, the 3D region annotation entity being associated with the volumetric media entity;
reading geometry data associated with the 3D region annotation entity and describing the geometry of a region of the volumetric media;
reading at least one annotation data structure associated with the 3D region annotation entity for obtaining annotation data; and
processing the obtained volumetric media and the obtained at least one annotation data in function of the geometry of the region of the volumetric media.
